(19) United States
(12) Patent Application Publication
(10) Pub. No.: US 2024/0127295 A1
(43) Pub. Date: Apr. 18, 2024

(54) INFORMATION PROCESSING SYSTEM, INFORMATION PROCESSING APPARATUS, INFORMATION PROCESSING METHOD, AND NON-TRANSITORY RECORDING MEDIUM

(71) Applicants: Hiroyuki MATSUSHIMA, Kanagawa (JP); Yoshihiko ABE, Kanagawa (JP); Bumpei SAKAI, Kanagawa (JP)

(72) Inventors: Hiroyuki MATSUSHIMA, Kanagawa (JP); Yoshihiko ABE, Kanagawa (JP); Bumpei SAKAI, Kanagawa (JP)

(21) Appl. No.: 18/376,869

(22) Filed: Oct. 5, 2023

(30) Foreign Application Priority Data
Oct. 14, 2022 (JP) 2022-165805

(51) Int. Cl. G06Q 30/0241; G06F 16/955

(52) U.S. Cl. CPC G06Q 30/0276; G06F 16/9566; G06Q 30/0277

(57) ABSTRACT

An information processing system includes circuitry that creates first marketing data including first content and first uniform resource locator (URL) information. The first content is specified in accordance with an operation performed on a first information terminal. The first URL information is according to a customer. In response to access by a terminal of the customer to a page indicated by the first URL information after a first medium based on the first marketing data is delivered to the customer, the circuitry transmits an access notification to a second information terminal to notify the access to the page indicated by the first URL information. The circuitry receives second content information related to the access notification and specified in accordance with an operation performed on the second information terminal. The circuitry creates second marketing data related to the customer and including second content indicated by the received second content information.

### CROSS-REFERENCE TO RELATED APPLICATION

This patent application is based on and claims priority pursuant to 35 U.S.C. § 119(a) to Japanese Patent Application No. 2022-165805, filed on Oct. 14, 2022, in the Japan Patent Office, the entire disclosure of which is hereby incorporated by reference herein.

### BACKGROUND

### Technical Field

Embodiments of this disclosure relate to an information processing system, an information processing apparatus, an information processing method, and a non-transitory recording medium.

### Related Art

In recent years, corporate marketing has been shifting to digital. On the other hand, the use of direct mail (DM) as well as electronic mail (email) is being reevaluated.

Marketing utilizing both digital technologies and the DM, however, involves many tools and tasks.

For example, as a marketing technique utilizing digital technologies and the DM, there is a system that prints on a DM a quick response code (QR Code®) containing a uniform resource locator (URL) associated with a customer identifier (ID) of a customer. Based on a history of access of the customer to the URL via the QR code, the system selects the next information to be posted and presented to the customer and outputs a next DM printed with a QR code containing a URL of the information.

### SUMMARY

In one embodiment of this invention, there is provided an information processing system that includes, for example, circuitry. The circuitry creates first marketing data including first content and first uniform resource locator (URL) information. The first content is specified in accordance with an operation performed on a first information terminal. The first URL information is according to a customer. In response to access by a terminal of the customer to a page indicated by the first URL information included in the first marketing data after a first medium based on the first marketing data is delivered to the customer, the circuitry transmits an access notification to a second information terminal to notify the access to the page indicated by the first URL information. The circuitry further receives second content information related to the access notification and specified in accordance with an operation performed on the second information terminal, and creates second marketing data related to the customer and including second content indicated by the received second content information.

In one embodiment of this invention, there is provided an information processing apparatus that includes, for example, the above-described circuitry.

In one embodiment of this invention, there is provided an information processing method that includes, for example, creating first marketing data including first content and first URL information. The first content is specified in accordance with an operation performed on a first information terminal. The first URL information is according to a customer. The information processing method further includes, in response to access by a terminal of the customer to a page indicated by the first URL information included in the first marketing data after a first medium based on the first marketing data is delivered to the customer, transmitting an access notification to a second information terminal to notify the access to the page indicated by the first URL information, receiving second content information related to the access notification and specified in accordance with an operation performed on the second information terminal, and creating second marketing data related to the customer and including second content indicated by the received second content information.

In one embodiment of this invention, there is provided a non-transitory recording medium storing a plurality of instructions which, when executed by one or more processors, causes the processors to perform the above-described information processing method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a schematic configuration of an equipment system according to an embodiment of the present invention;

FIG. 2 is a diagram illustrating an overview of overall operation of the equipment system of the embodiment;

FIG. 3 is a diagram illustrating an exemplary hardware configuration of an apparatus, such as a marketing support system, included in the equipment system of the embodiment;

FIG. 4 is a diagram illustrating an exemplary hardware configuration of a printing machine included in the equipment system of the embodiment;

FIG. 5 is a diagram illustrating an exemplary hardware configuration of a terminal apparatus, such as a sales representative terminal, included in the equipment system of the embodiment;

FIGS. 6A and 6B (FIG. 6) are diagrams illustrating an exemplary functional block configuration of the equipment system of the embodiment;

FIG. 7 is a diagram illustrating an exemplary data model used in the equipment system of the embodiment;

FIG. 8 is a sequence diagram illustrating an exemplary procedure of a campaign registration process in the equipment system of the embodiment;

FIG. 9 is a diagram illustrating an example of a campaign list screen of the embodiment;

FIG. 10 is a diagram illustrating an example of a new campaign creation screen of the embodiment;

FIG. 11 is a diagram illustrating an example of a campaign information screen of the embodiment;

FIG. 12 is a diagram illustrating an example of a template selection screen of the embodiment;

FIG. 13 is a diagram illustrating an example of a destination registration screen of the embodiment;

FIG. 14 is a sequence diagram illustrating an exemplary procedure of a campaign start process in the equipment system of the embodiment;

FIG. 15 is a diagram illustrating an example of the campaign information screen of the embodiment when a campaign is ongoing;

FIG. 16 is a diagram illustrating an example of a direct mail (DM) of the embodiment to be delivered to a customer;

FIG. 17 is a sequence diagram illustrating an exemplary procedure of a landing page (LP) access process of accessing an LP from a customer terminal in the equipment system of the embodiment;

FIG. 18 is a diagram illustrating an example of a detailed campaign status screen of the embodiment;

FIG. 19 is a sequence diagram illustrating an exemplary procedure of an action execution process in the equipment system of the embodiment;

FIGS. 20A, 20B, 20C, 20D, and 20E are diagrams illustrating examples of an application screen displayed on the sales representative terminal of the embodiment;

FIG. 21 is a diagram illustrating an example of an electronic mail (email) of the embodiment to be delivered to the customer terminal; and

FIG. 22A is a diagram illustrating an example of the application screen displayed on the sales representative terminal in a modified example of the embodiment; and

FIG. 22B is a diagram illustrating an example of the application screen displayed on a hotel terminal in the modified example of the embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, an information processing system, an information processing apparatus, an information processing method, and a non-transitory recording medium according to an embodiment of the present disclosure are described below. As used herein, the singular forms “a,” “an,” and “the” are intended to include the plural forms as well, unless the context clearly indicates otherwise.

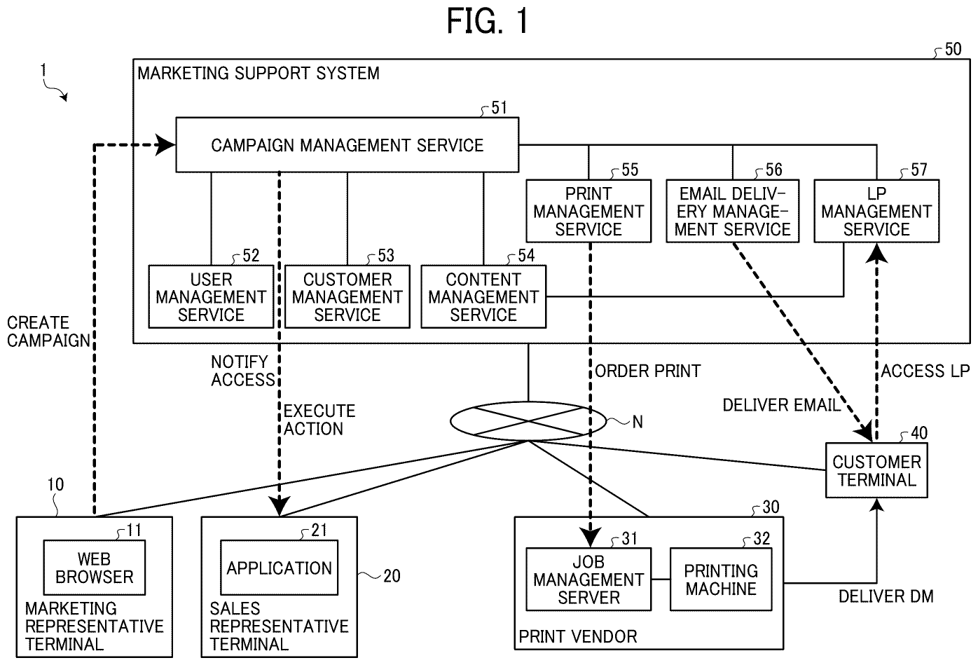

FIG. 1 is a diagram illustrating a schematic configuration of an equipment system according to the embodiment. A schematic configuration of an equipment system 1 of the embodiment will be described with reference to FIG. 1.

The equipment system 1 illustrated in FIG. 1 is an information processing system for implementing marketing utilizing digital technologies and direct mail (DM). As illustrated in FIG. 1, the equipment system 1 includes a marketing support system 50, a marketing representative terminal 10 (a first information terminal), a sales representative terminal 20 (a second information terminal), a job management server 31 and a printing machine 32 of a print vendor 30, and a customer terminal 40. The marketing support system 50, the marketing representative terminal 10, the sales representative terminal 20, the job management server 31, and the customer terminal 40 are able to communicate data to each other via a network N. Terminal apparatuses such as the first information terminal and the second information terminal may be implemented by a single information terminal.

In the present embodiment, in which the marketing support system 50 is built in the cloud, the network N includes the Internet. The print vendor 30 uses a network such as a local area network (LAN) or a wide area network (WAN). The network N may use a virtual private network (VPN).

The print vendor 30 refers to a vendor with a facility for printing, such as a printing plant, a printing house, or a designated building. The print vendor 30 has a system including the job management server 31 and the printing machine 32. The job management server 31 and the printing machine 32 may be able to communicate data to each other via a network built in the system of the print vendor 30.

The job management server 31 is an information processing apparatus, such as a personal computer (PC) or a workstation, that instructs the printing machine 32 to execute a job in response to receipt of job information transmitted from the marketing support system 50 as a print order.

The above-described job refers to a unit of print processing, e.g., printing a certain number of pages of a certain document. In the present embodiment, printing by the printing machine 32 is the execution of a job. However, the specific process of executing a job varies depending on the type of the printing machine 32. The job information is information related to a job. In the present embodiment, the job and the job information are not strictly distinguished from each other.

The printing machine 32 is an image forming apparatus such as a production printer, a color inkjet printer, or a color and monochrome multifunction peripheral (MFP). The printing method of the printing machine 32 may be the electrophotographic, inkjet, letterpress, intaglio, planographic, or stencil printing, for example. However, the printing machine 32 is not limited to any of these methods, and may employ any printing method applicable thereto. The printing machine 32 may be connected to a finisher (i.e., a post-processing apparatus) to perform, on printed recording media, post-processing such as folding, saddle stitch binding, case binding, or punching. The printing machine 32 may also have a scanner function, a facsimile (FAX) function, or a copier function, for example.

If the printing machine 32 is commercial printing machinery, the printing machine 32 is controlled by a digital front end (DFE). Therefore, an apparatus independent of the printing machine 32 may include the DFE. In the following description of the present embodiment, it is assumed that the printing machine 32 is equipped with a control function of the DFE.

The marketing representative terminal 10 is an information terminal, such as a PC, used by a marketing representative in charge of a specific good or service, for example, to register in the marketing support system 50 the information of a campaign for selling or offering the specific good or service. The marketing representative terminal 10 further displays, on a world wide web (Web) browser 11, screens for registering the information of the campaign for selling or offering the specific good or service.

The sales representative terminal 20 is an information terminal, such as a smartphone or a tablet terminal, for executing an action toward a customer selected as desired by a sales representative after the campaign registered by the marketing representative terminal 10 is executed and a landing page (LP) is accessed from a DM or electronic mail (email) delivered to the customer. The sales representative terminal 20 executes an application 21 to implement the above-described operation. The application 21 may be a native application or a Web application.

The customer terminal 40 is an information terminal, such as a smartphone or a tablet terminal, used by the customer targeted in the above-described campaign to access the particular LP via, for example, a link included in the email delivered from the marketing support system 50 or in the DM delivered from the print vendor 30.

The marketing support system 50 is an information processing system including one or more information processing apparatuses to support marketing by placing a print order for the DM with the print vendor 30 or delivering the email to the customer terminal 40 in accordance with the campaign created and registered by the marketing representative terminal 10. The marketing support system 50 is implemented by a cloud system, for example.

Herein, the term “cloud” is an abbreviation for “cloud computing,” which refers to a form of use in which a resource in a network is used without recognition of a specific hardware resource. The term “cloud” is used in contrast with the term “on-premise” (i.e., in a facility managed by a user). The marketing support system 50, however, may be located outside or inside an in-house LAN. The one or more information processing apparatuses included in the marketing support system 50 function as a server to provide various information and processing results in response to requests from clients.

As illustrated in FIG. 1, the marketing support system 50 includes a campaign management service 51, a user management service 52, a customer management service 53, a content management service 54, a print management service 55, an email delivery management service 56, and an LP management service 57. The marketing support system 50 may include servers corresponding to the respective services, or may include one or more servers implementing the services. Applications corresponding to the respective services are running on the servers, and are communicable with each other. The applications communicate with each other via a Web application programming interface (API), for example. Although not strictly defined, a Web API is an interface between applications or systems invoked over a network with a protocol such as hypertext transfer protocol (HTTP).

The campaign management service 51 creates the information of the campaign in accordance with an operation performed on the marketing representative terminal 10, and manages the execution of the campaign. The campaign management service 51 further manages the execution of the action toward the customer selected as desired on the sales representative terminal 20. If the LP is accessed from the customer terminal 40, the campaign management service 51 also transmits a notification of the access to the sales representative terminal 20. In this case, a communications protocol called WebSocket, for example, may be used to transmit the notification to the sales representative terminal 20 from the campaign management service 51 on the cloud. Alternatively, the sales representative terminal 20 may perform long polling to allow the campaign management service 51 to transmit the notification.

The user management service 52 manages the information of a user (e.g., the marketing representative or a sales representative) who uses the marketing support system 50.

The customer management service 53 manages the information of the customer targeted in the campaign by the user of the marketing support system 50.

The content management service 54 manages digital materials (content), such as design templates and illustrations, to be included in the DM or email that is delivered to the customer from the marketing representative terminal 10 or the sales representative terminal 20.

The print management service 55 transmits a DM print order to the job management server 31 of the print vendor 30 in accordance with the campaign created by the marketing representative terminal 10 or the action created by the sales representative terminal 20. In this case, the transmission of the DM print order to the job management server 31 from the print management service 55 on the cloud may be implemented with, for example, WebSocket or long polling, as described above.

The email delivery management service 56 delivers the email to the customer terminal 40 in accordance with the campaign created by the marketing representative terminal or the action created by the sales representative terminal 20. In this case, the delivery of the email to the customer terminal 40 from the email delivery management service 56 on the cloud may be implemented with, for example, a mail server provided by a cloud service provider or an Internet service provider.

The LP management service 57 is a service that receives the access of the customer terminal 40 to the particular LP via a uniform resource locator (URL) included in a quick response code (QR Code®) on the DM or indicated by a link in the email, and provides a Web page forming the LP.

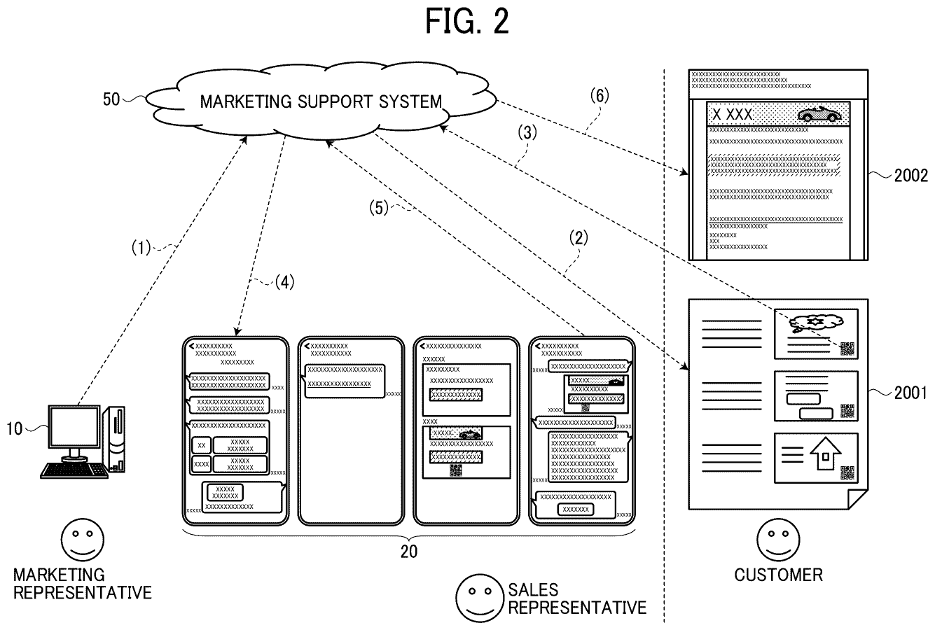

FIG. 2 is a diagram illustrating an overview of overall operation of the equipment system 1 according to the embodiment. An overview of the overall operation of the equipment system 1 according to the embodiment will be described with reference to FIG. 2.

With the marketing representative terminal 10, the marketing representative first accesses the marketing support system 50 and creates the information of the campaign for selling or offering the specific good or service (i.e., creates the campaign, as indicated by an arrow (1) in FIG. 2). Hereinafter, the information of the campaign will be occasionally referred to as the campaign information. In this process, the marketing representative specifies the type, i.e., whether to use DM or email in the campaign, selects the destination of the customer to whom the DM or email is to be delivered, selects a template to be included in the DM or email, and registers variable data to be included in the template, for example.

When the creation of the campaign is completed or when the start date included in the created campaign information arrives, the marketing support system 50 creates marketing data to be delivered to the customer as the destination with the information of the destination and the template included in the campaign information and the variable data. Herein, when the type is DM, the marketing data refers to print data for printing the DM. When the type is email, the marketing data refers to email data. In the following description of the example illustrated in FIG. 2, it is assumed that the type included in the campaign information is DM, and that the marketing support system 50 has created the print data for printing the DM as the marketing data. The marketing support system 50 then transmits job information including the created print data to the job management server 31 of the print vendor 30 to place a print order. The job management server 31 prints out a DM 2001 with the print data included in the received job information. The print vendor 30 sends (delivers) the printed DM 2001 to the address of the customer specified in the print data (i.e., sends the DM, as indicated by an arrow (2) in FIG. 2).

In response to receipt of the DM 2001, the customer reads the QR code on the DM 2001 with the customer terminal 40 to access the URL of the LP indicated by the QR code (i.e., accesses the URL via the QR code, as indicated by an arrow (3) in FIG. 2).

In response to receipt of a request to access the LP from the customer terminal 40, the marketing support system 50 transmits a notification to the sales representative terminal 20 of the sales representative in charge of the customer to notify that the DM 2001 has been opened and that the LP has been accessed (i.e., notifies the opening of the DM, as indicated by an arrow (4) in FIG. 2).

Then, with the sales representative terminal 20, the sales representative checks the access of the customer to the LP, and sets and executes an effective action toward the customer as the next activity of the campaign (i.e., makes a response, as indicated by an arrow (5) in FIG. 2). Specifically, with the sales representative terminal 20, the sales representative specifies to the marketing support system 50 whether to use DM or email as the action, selects the template to be included in the DM or email, and registers the variable data (e.g., text) to be included in the template, for example. The above-described information is created and managed in the marketing support system 50 as action information.

With the information of the template and the variable data included in the created action information, the marketing support system 50 then creates new marketing data to be delivered to the customer. In the following description of the example illustrated in FIG. 2, it is assumed that the type included in the action information is email, and that the marketing support system 50 has created the email data of an email 2002 to be delivered as the marketing data. Then, the marketing support system 50 delivers (transmits) the created email data of the email 2002 to the customer terminal 40 of the customer (i.e., transmits the email, as indicated by an arrow (6) in FIG. 2). Thereby, the customer checks the email 2002, which is related to the content of the previously received DM 2001. Consequently, the effectiveness of the campaign for the good or service is improved.

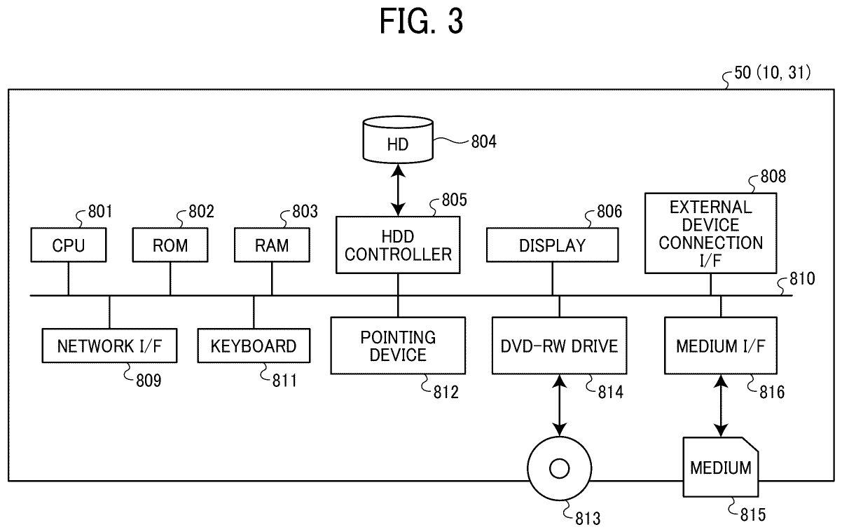

FIG. 3 is a diagram illustrating an exemplary hardware configuration of an apparatus of the embodiment such as the marketing support system 50. A hardware configuration of the marketing support system 50, the marketing representative terminal 10, or the job management server 31 will be described with reference to FIG. 3. Although a configuration of the marketing support system 50 will be described here as an example, a similar configuration applies to the marketing representative terminal 10 and the job management server 31.

As illustrated in FIG. 3, the marketing support system 50 includes a central processing unit (CPU) 801, a read only memory (ROM) 802, a random access memory (RAM) 803, a hard disk (HD) 804, a hard disk drive (HDD) controller 805, a display 806, an external device connection interface (I/F) 808, a network I/F 809, a keyboard 811, a pointing device 812, a digital versatile disk-rewritable (DVD-RW) drive 814, and a medium I/F 816. These devices are connected to each other by a bus line 810, which includes address buses and data buses, to enable data communication therebetween.

The CPU 801 is an arithmetic device that controls overall operation of the marketing support system 50. The ROM 802 is a nonvolatile storage device that stores a program used to drive the CPU 801, such as an initial program loader (IPL). The RAM 803 is a volatile storage device used as a working area of the CPU 801.

The HD 804 is a nonvolatile auxiliary storage device that stores various data such as programs. The HDD controller 805 is a controller that controls writing and reading of various data to and from the HD 804 under the control of the CPU 801. The HD 804 and the HDD controller 805 may each be a solid state drive (SSD).

The display 806 is a display device that displays various information such as a cursor, menus, windows, text, and images. The external device connection I/F 808 is an interface for connecting various external devices to the marketing support system 50. The external devices in this case include a universal serial bus (USB) memory and a printer, for example. The network IN 809 is an interface for performing data communication via the network N. For example, the network I/F 809 is an interface enabling communication conforming to protocols such as Ethernet® and transmission control protocol/internet protocol (TCP/IP).

The keyboard 811 is an input device including a plurality of keys for inputting characters, numerical values, and various instructions, for example. The pointing device 812 is an input device, such as a mouse, for selecting and executing various instructions, selecting a processing target, and moving the cursor, for example.

The DVD-RW drive 814 is a device that controls writing and reading of various data to and from a DVD 813 such as a DVD-recordable (DVD-R) or a DVD-RW as an example of a removable recording medium. The medium I/F 816 is an interface that controls writing (storage) and reading of data to and from a medium 815 such as a flash memory.

The marketing support system 50 is often implemented by a virtual machine. A virtual machine refers to an information processing apparatus with an operating system (OS) running on a host OS.

The hardware configuration of the marketing support system 50, the marketing representative terminal 10, or the job management server 31 illustrated in FIG. 3 is illustrative. The marketing support system 50, the marketing representative terminal 10, or the job management server 31 is not necessarily required to include all of the components illustrated in FIG. 3. Further, the marketing support system 50, the marketing representative terminal 10, or the job management server 31 may include a component other than those illustrated in FIG. 3. Furthermore, the marketing support system 50, the marketing representative terminal 10, and the job management server 31 are not required to have the same hardware configuration. As described above, the marketing support system 50 may include servers corresponding to the respective services, or may include one or more servers implementing the services.

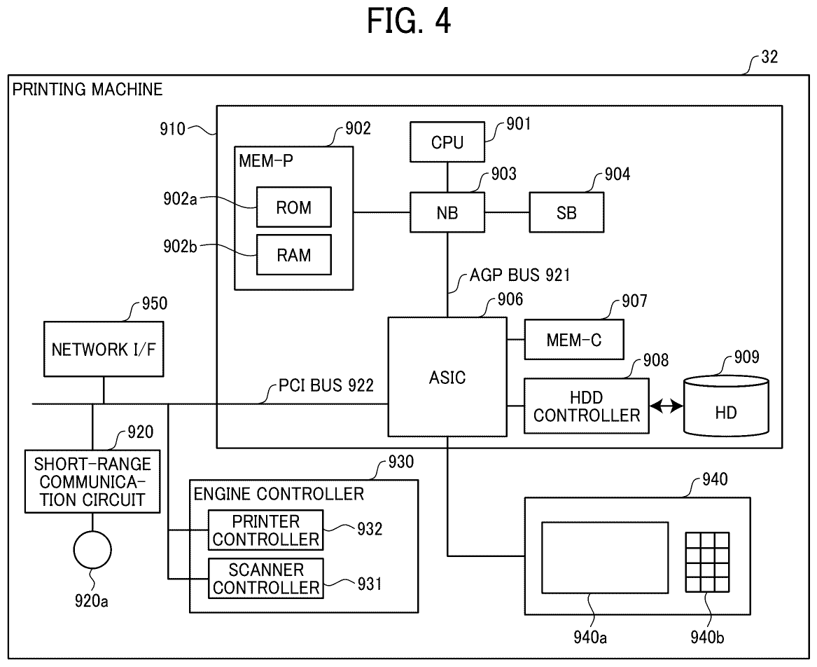

FIG. 4 is a diagram illustrating an exemplary hardware configuration of the printing machine 32 of the embodiment. A hardware configuration of the printing machine 32 will be described with reference to FIG. 4.

As illustrated in FIG. 4, the printing machine 32 includes a controller 910, a short-range communication circuit 920, an engine controller 930, an operation panel 940, and a network IN 950.

The controller 910 includes a CPU 901 as a major component of a computer forming the printing machine 32, a system memory (MEM-P) 902, a north bridge (NB) 903, a south bridge (SB) 904, an application specific integrated circuit (ASIC) 906, a local memory (MEM-C) 907, an HDD controller 908, and an HD 909. The NB 903 and the ASIC 906 are connected to each other by an accelerated graphics port (AGP) bus 921.

The CPU 901 is an arithmetic device that performs overall control of the printing machine 32. The NB 903 is a bridge for connecting the CPU 901, the MEM-P 902, the SB 904, and the AGP bus 921 to each other. The NB 903 includes a memory controller that controls data writing and reading to and from the MEM-P 902, a peripheral component interconnect (PCI) master, and an AGP target.

The MEM-P 902 includes a ROM 902a and a RAM 902b. The ROM 902a is a memory for storing programs and data for implementing functions of the controller 910. The RAM 902b is used as a memory in deploying a program or data or as a rendering memory in memory printing, for example. Each of the programs stored in the ROM 902a and deployed into the RAM 902b may be provided as recorded on a computer readable recording medium, such as a compact disc-ROM (CD-ROM), a CD-recordable (CD-R), or a DVD, in an installable or executable file format.

The SB 904 is a bridge for connecting the NB 903 to a PCI device and a peripheral device, for example. The ASIC 906, which is an integrated circuit (IC) for image processing, includes hardware components for image processing. The ASIC 906 functions as a bridge for connecting the AGP bus 921, a PCI bus 922, the HDD controller 908, and the MEM-C 907 to each other. The ASIC 906 includes a PCI target, an AGP master, an arbiter (ARB) as a core component of the ASIC 906, a memory controller that controls the MEM-C 907, a plurality of direct memory access controllers (DMACs) that perform processes such as the rotation of image data with a hardware logic, and a PCI unit that transfers data to and from a scanner controller 931 or a printer controller 932 of the engine controller 930 via the PCI bus 922. The ASIC 906 may be connected to an interface such as a USB interface or an institute of electrical and electronics engineers (IEEE) 1394 interface.

The MEM-C 907 is a local memory used as a copy image buffer and a code buffer. The HD 909 is a storage device for accumulating image data, font data for use in printing, and form data. The HDD controller 908 is a controller that controls data writing and reading to and from the HD 909 under the control of the CPU 901. The HDD controller 908 and the HD 909 may each be an SSD.

The AGP bus 921 is a bus interface for a graphics accelerator card proposed to speed up graphics processing. The AGP bus 921 enables the graphics accelerator card to directly access the MEM-P 902 with a high throughput, thereby implementing a high-speed graphics accelerator card.

The short-range communication circuit 920 is a communication circuit conforming to a standard such as near field communication (NFC) or Bluetooth®. The short-range communication circuit 920 is electrically connected to the ASIC 906 via the PCI bus 922. The short-range communication circuit 920 is connected to an antenna 920a for wireless communication.

The engine controller 930 includes the scanner controller 931 and the printer controller 932. Each of the scanner controller 931 and the printer controller 932 includes an image processing function that performs processing such as error diffusion or gamma conversion.

The operation panel 940 includes a panel display 940a such as a touch panel and hardware keys 940b. The panel display 940a displays the current setting values or a selection screen, for example, and receives an input from a user. The hardware keys 940b include keys such as numeric keys for receiving the setting values of conditions related to image formation such as a density setting condition and a start key for receiving a copy start instruction.

With an application switch key included in the operation panel 940, the function of the printing machine 32 is sequentially switched to a document box function, a copier function, a printer function, and a FAX function to select a desired function. When the document box function is selected, the printing machine 32 is switched to document box mode. When the copier function is selected, the printing machine 32 is switched to copy mode. When the printer function is selected, the printing machine 32 is switched to printer mode. When the FAX function is selected, the printing machine 32 is switched to FAX mode.

The network I/F 950 is an interface for performing data communication via the network N. The network I/F 950 is an interface enabling communication conforming to Ethernet and TCP/IP, for example. The network I/F 950 is electrically connected to the ASIC 906 via the PCI bus 922.

The hardware configuration of the printing machine 32 illustrated in FIG. 4 is illustrative. The printing machine 32 is not necessarily required to include all of the components illustrated in FIG. 4. Further, the printing machine 32 may include a component other than those illustrated in FIG. 4.

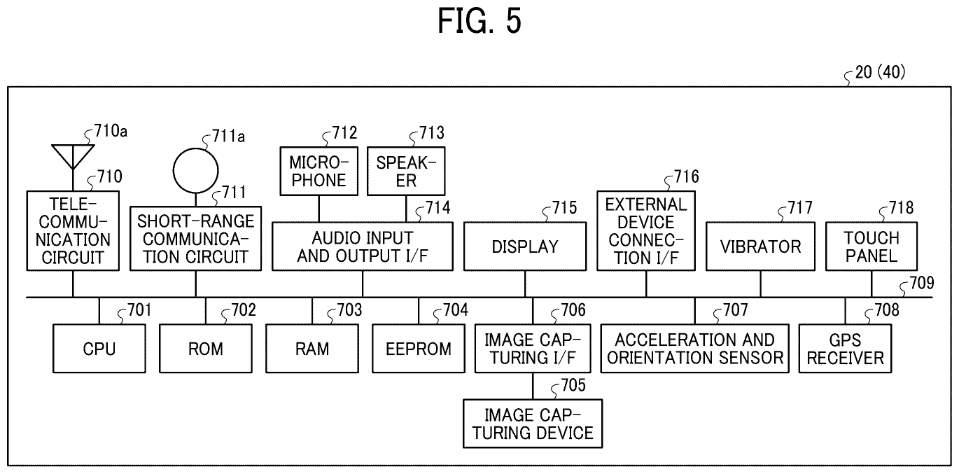

FIG. 5 is a diagram illustrating an exemplary hardware configuration of a terminal apparatus (e.g., the first information terminal, the second information terminal, or a third information terminal) of the embodiment, such as the sales representative terminal 20. A hardware configuration of the sales representative terminal 20 or the customer terminal 40 will be described with reference to FIG. 5. Although a configuration of the sales representative terminal 20 will be described here as an example, a similar configuration applies to the customer terminal 40.

As illustrated in FIG. 5, the sales representative terminal 20 includes a CPU 701, a ROM 702, a RAM 703, an electrically erasable programmable read only memory (EEPROM) 704, an image capturing device 705, an image capturing I/F 706, an acceleration and orientation sensor 707, and a global positioning system (GPS) receiver 708.

The CPU 701 is an arithmetic device that controls overall operation of the sales representative terminal 20. The ROM 702 is a nonvolatile storage device that stores a program used to drive the CPU 701, such as an IPL. The RAM 703 is a volatile storage device used as a working area of the CPU 701. The EEPROM 704 is a nonvolatile storage device that stores programs and various data.

The image capturing device 705 is a built-in image capturing device that obtains image data by capturing the image of a subject with an image sensor such as a complementary metal oxide semiconductor (CMOS) under the control of the CPU 701. The image sensor may be a charge coupled device (CCD) instead of the CMOS. The image capturing I/F 706 is an interface for controlling the driving of the image capturing device 705.

The acceleration and orientation sensor 707 includes various types of sensors such as an electromagnetic compass that detects geomagnetism, a gyrocompass, and an acceleration sensor.

The GPS receiver 708 is a receiver device that receives GPS signals from GPS satellites. The signals received by the GPS receiver 708 are not limited to the GPS signals from the GPS satellites, and may be positioning signals from positioning satellites based on commonly used global navigation satellite systems (GNSS).

As illustrated in FIG. 5, the sales representative terminal 20 further includes a telecommunication circuit 710, an antenna 710a, a short-range communication circuit 711, an antenna 711a, a microphone 712, a speaker 713, an audio input and output I/F 714, a display 715, an external device connection IN 716, a vibrator 717, and a touch panel 718.

The telecommunication circuit 710 is a communication circuit that performs wireless communication with another device via the antenna 710a and a network in accordance with a standard such as wireless fidelity (Wi-Fi®).

The short-range communication circuit 711 is a communication circuit that performs short-range wireless communication with another device via the antenna 711a in accordance with a standard such as NFC or Bluetooth®.

The microphone 712 is a built-in sound collecting device that converts sound into electrical signal. The speaker 713 is a built-in audio device that converts electrical signal into physical vibration to output the sound of music or voice, for example. The audio input and output I/F 714 is an interface that processes the input of audio signal from the microphone 712 and the output of audio signal to the speaker 713 under the control of the CPU 701. The display 715 is a display device, such as a liquid crystal or organic electroluminescence (EL) display, that displays the image of the subject and various icons, for example. The external device connection I/F 716 is an interface conforming to a standard such as USB for connecting various external devices to the sales representative terminal 20.

The vibrator 717 is a device that causes physical vibration under the control of the CPU 701.

The touch panel 718 is an input device for implementing various functions of the sales representative terminal 20 in response to touch on the display 715 by a user.

The CPU 701, the ROM 702, the RAM 703, the EEPROM 704, the image capturing I/F 706, the acceleration and orientation sensor 707, the GPS receiver 708, the telecommunication circuit 710, the short-range communication circuit 711, the audio input and output I/F 714, the display 715, the external device connection I/F 716, the vibrator 717, and the touch panel 718 are communicably connected to each other by a bus line 709 including address buses and data buses.

The hardware configuration of the sales representative terminal 20 illustrated in FIG. is illustrative. The sales representative terminal 20 is not necessary required to include all of the components illustrated in FIG. 5. Further, the sales representative terminal 20 may include a component other than those illustrated in FIG. 5. Furthermore, the sales representative terminal 20 and the customer terminal 40 are not required to have the same hardware configuration.

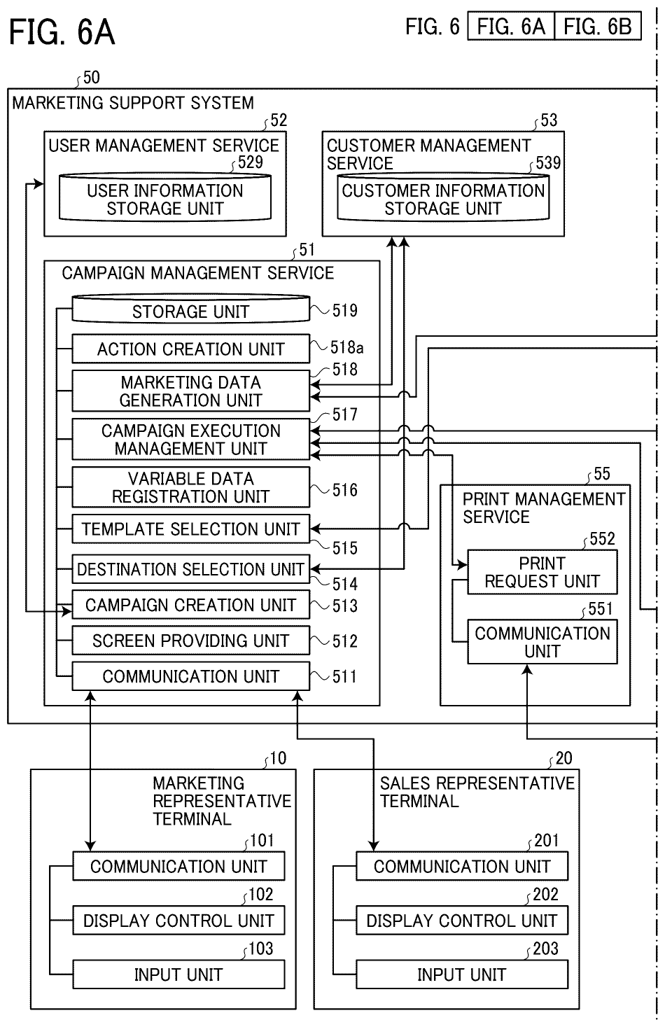

FIGS. 6A and 6B (FIG. 6) are diagrams illustrating an exemplary functional block configuration of the equipment system 1 of the embodiment. A configuration and operation of functional blocks of the equipment system 1 will be described with reference to FIG. 6. The functional units illustrated in FIG. 6 may be distributed to a plurality of apparatuses or systems.

As illustrated in FIG. 6, the campaign management service 51 of the marketing support system 50 includes a communication unit 511 (a reception unit), a screen providing unit 512, a campaign creation unit 513, a destination selection unit 514, a template selection unit 515, a variable data registration unit 516, a campaign execution management unit 517 (an example of a notification unit), a marketing data generation unit 518 (an example of a first creation unit and an example of a second creation unit), an action creation unit 518a, and a storage unit 519. The marketing data generation unit 518 may be a single creation unit, or may include a plurality of creation units (e.g., the first creation unit and the second creation unit) corresponding to the respective types of marketing data.

The communication unit 511 is a functional unit that transmits and receives various information to and from an external device. The communication unit 511 is implemented by the network I/F 809 and a program executed by the CPU 801 illustrated in FIG. 3, for example.

The screen providing unit 512 is a functional unit that provides the marketing representative terminal 10 with the information of screens for creating, checking, and editing the campaign information, such as a campaign list screen 1000 and a new campaign creation screen 1100, which will be described later.

The campaign creation unit 513 is a functional unit that, in accordance with an operation performed on the marketing representative terminal 10, determines the content of the campaign and creates the campaign information including the content.

The destination selection unit 514 is a functional unit that, in accordance with an operation performed on the marketing representative terminal 10, selects the destination of the customer to whom the DM or email is to be delivered, and registers the selected destination in the campaign information.

The template selection unit 515 is a functional unit that, in accordance with an operation performed on the marketing representative terminal 10, selects the template to be included in the DM or email, and registers the selected template in the campaign information.

The variable data registration unit 516 is a functional unit that acquires the variable data input with the marketing representative terminal 10 to be included in the DM or email, and registers the acquired variable data in the campaign information.

The campaign execution management unit 517 is a functional unit that executes the campaign based on the campaign information when the creation of the campaign by the campaign creation unit 513 is completed or when the start date included in the created campaign information arrives. The campaign execution management unit 517 is also a functional unit that executes the action based on the action information created by the action creation unit 518a in accordance with an operation performed on the sales representative terminal 20.

The marketing data generation unit 518 is a functional unit that generates the marketing data in accordance with the campaign information or the action information. The marketing data generation unit 518 may be divided into separate functional blocks: a functional block for a function of generating the marketing data in accordance with the campaign information and a functional block for a function of generating the marketing data in accordance with the action information.

The action creation unit 518a is a functional unit that creates the action information in accordance with an operation performed on the sales representative terminal 20 after the access of the customer to the LP is checked on the sales representative terminal 20. The action information is set with an effective action toward the customer as the next activity of the campaign.

The storage unit 519 is a functional unit that stores information such as the campaign information, the action information, and various screen information. The storage unit 519 is implemented by at least one of the RAM 803 or the HD 804 illustrated in FIG. 3.

The screen providing unit 512, the campaign creation unit 513, the destination selection unit 514, the template selection unit 515, the variable data registration unit 516, the campaign execution management unit 517, the marketing data generation unit 518, and the action creation unit 518a are implemented by a program executed by the CPU 801 illustrated in FIG. 3, for example. Part or all of these functional units may be implemented by an integrated circuit such as a field programmable gate array (FPGA) or an ASIC instead of a program as software.

Each of the functional units of the campaign management service 51 illustrated in FIG. 6 is a conceptual representation of a function, and is not limited to the configuration illustrated in FIG. 6. For example, a plurality of functional units illustrated as separate functional units of the campaign management service 51 in FIG. 6 may be configured as a single functional unit. Further, the function of any of the functional units of the campaign management service 51 illustrated in FIG. 6 may be divided into a plurality of functions to form a plurality of functional units.

The user management service 52 of the marketing support system 50 includes a user information storage unit 529, as illustrated in FIG. 6.

The user information storage unit 529 is a functional unit that stores the information of the user (e.g., the marketing representative or the sales representative) of the marketing support system 50 as user information. The user information storage unit 529 is implemented by at least one of the RAM 803 or the HD 804 illustrated in FIG. 3.

The customer management service 53 of the marketing support system 50 includes a customer information storage unit 539, as illustrated in FIG. 6.

The customer information storage unit 539 stores the information of the customer targeted in the campaign by the user of the marketing support system 50 as customer information. The customer information storage unit 539 is implemented by at least one of the RAM 803 or the HD 804 illustrated in FIG. 3.

The content management service 54 of the marketing support system 50 includes a content storage unit 549, as illustrated in FIG. 6. The content storage unit 549 is a functional unit that stores digital materials (content) such as the template to be included in the DM or email that is delivered to the customer. The content storage unit 549 is implemented by at least one of the RAM 803 or the HD 804 illustrated in FIG. 3.

The print management service 55 of the marketing support system 50 includes a communication unit 551 and a print request unit 552, as illustrated in FIG. 6.

The communication unit 551 is a functional unit that performs data communication with the job management server 31 of the print vendor 30. The communication unit 551 is implemented by the network I/F 809 and a program executed by the CPU 801 illustrated in FIG. 3, for example.

The print request unit 552 is a functional unit that transmits the job information to the job management server 31 of the print vendor 30 via the communication unit 551 to make a print order request. The job information includes the print data of the DM as the marketing data generated by the marketing data generation unit 518.

The print request unit 552 is implemented by a program executed by the CPU 801 illustrated in FIG. 3, for example. Alternatively, the print request unit 552 may be implemented by an integrated circuit such as an FPGA or an ASIC instead of a program as software.

Each of the functional units of the print management service 55 illustrated in FIG. 6 is a conceptual representation of a function, and is not limited to the configuration illustrated in FIG. 6. For example, a plurality of functional units illustrated as separate functional units of the print management service 55 in FIG. 6 may be configured as a single functional unit. Further, the function of any of the functional units of the print management service 55 illustrated in FIG. 6 may be divided into a plurality of functions to form a plurality of functional units.

The email delivery management service 56 of the marketing support system 50 includes a communication unit 561, an email delivery unit 562, and an email data storage unit 569, as illustrated in FIG. 6.

The communication unit 561 is a functional unit that performs data communication with a mail server. The communication unit 561 is implemented by the network IN 809 and a program executed by the CPU 801 illustrated in FIG. 3, for example.

The email delivery unit 562 is a functional unit that delivers the email data of the email generated by the marketing data generation unit 518 as the marketing data to the customer terminal 40 via the communication unit 561 and the mail server.

The email data storage unit 569 is a functional unit that stores the email data of the email, which is generated by the marketing data generation unit 518 as the marketing data, until at least the transmission date of the email. The email data storage unit 569 is implemented by at least one of the RAM 803 or the HD 804 illustrated in FIG. 3.

The email delivery unit 562 is implemented by a program executed by the CPU 801 illustrated in FIG. 3, for example. Alternatively, the email delivery unit 562 may be implemented by an integrated circuit such as an FPGA or an ASIC instead of a program as software.

Each of the functional units of the email delivery management service 56 illustrated in FIG. 6 is a conceptual representation of a function, and is not limited to the configuration illustrated in FIG. 6. For example, a plurality of functional units illustrated as separate functional units of the email delivery management service 56 in FIG. 6 may be configured as a single functional unit. Further, the function of any of the functional units of the email delivery management service 56 illustrated in FIG. 6 may be divided into a plurality of functions to form a plurality of functional units.

The LP management service 57 of the marketing support system 50 includes a communication unit 571 and an LP management unit 572, as illustrated in FIG. 6.

The communication unit 571 is a functional unit that performs data communication with the customer terminal 40. The communication unit 571 is implemented by the network I/F 809 and a program executed by the CPU 801 illustrated in FIG. 3, for example.

The LP management unit 572 is a functional unit that receives the access of the customer terminal 40 to a particular LP via the URL included in the QR code on the DM or indicated by the link in the email, and provides the Web page forming the LP.

The LP management unit 572 is implemented by a program executed by the CPU 801 illustrated in FIG. 3, for example. Alternatively, the LP management unit 572 may be implemented by an integrated circuit such as an FPGA or an ASIC instead of a program as software.

Each of the functional units of the LP management service 57 illustrated in FIG. 6 is a conceptual representation of a function, and is not limited to the configuration illustrated in FIG. 6. For example, a plurality of functional units illustrated as separate functional units of the LP management service 57 in FIG. 6 may be configured as a single functional unit. Further, the function of any of the functional units of the LP management service 57 illustrated in FIG. 6 may be divided into a plurality of functions to form a plurality of functional units.

The marketing representative terminal 10 includes a communication unit 101, a display control unit 102, and an input unit 103, as illustrated in FIG. 6.

The communication unit 101 is a functional unit that transmits and receives various information to and from the campaign management service 51 of the marketing support system 50. For example, the communication unit 101 transmits a campaign creation instruction, the information of the selected destination or template, or the variable data to the campaign management service 51 in accordance with input of an operation received by the input unit 103. The communication unit 101 is implemented by the network I/F 809 and a program executed by the CPU 801 illustrated in FIG. 3, for example.

The display control unit 102 is a functional unit that controls a display operation of the display 806 of the marketing representative terminal 10. For example, the display control unit 102 causes the display 806 to display, via the Web browser 11, the screens for creating, checking, and editing the campaign information, such as the campaign list screen 1000 and the new campaign creation screen 1100, which will be described later. The display control unit 102 is implemented by a program executed by the CPU 801 illustrated in FIG. 3, for example. The program is an application program installed in the marketing representative terminal 10 or a Web browser, for example. Alternatively, the display control unit 102 may be implemented by an integrated circuit such as an FPGA or an ASIC instead of a program as software.

The input unit 103 is a functional unit that receives input of an operation performed by the marketing representative. The input unit 103 is implemented by the keyboard 811 and the pointing device 812 illustrated in FIG. 3 and a displayed program.

Each of the functional units of the marketing representative terminal 10 illustrated in FIG. 6 is a conceptual representation of a function, and is not limited to the configuration illustrated in FIG. 6. For example, a plurality of functional units illustrated as separate functional units of the marketing representative terminal 10 in FIG. 6 may be configured as a single functional unit. Further, the function of any of the functional units of the marketing representative terminal 10 illustrated in FIG. 6 may be divided into a plurality of functions to form a plurality of functional units.

The sales representative terminal 20 includes a communication unit 201, a display control unit 202, and an input unit 203, as illustrated in FIG. 6.

The communication unit 201 is a functional unit that transmits and receives various information to and from the campaign management service 51 of the marketing support system 50. For example, after the campaign registered by the marketing representative terminal 10 is executed and the LP is accessed from the DM or email delivered to the customer, the communication unit 201 transmits to the campaign management service 51 the information for executing the action toward the customer selected as desired by the sales representative. The communication unit 201 is implemented by the telecommunication circuit 710 and a program executed by the CPU 701 illustrated in FIG. 5, for example.

The display control unit 202 is a functional unit that controls a display operation of the display 715 of the sales representative terminal 20. For example, after the campaign registered by the marketing representative terminal 10 is executed and the LP is accessed from the DM or email delivered to the customer, the display control unit 202 causes the display 715 to display a screen for executing the action toward the customer selected as desired by the sales representative. The display control unit 202 is implemented by a program executed by the CPU 701 illustrated in FIG. 5, for example. The program is an application program installed in the sales representative terminal 20 or a Web browser, for example. The screen for executing the action may be implemented by, for example, a chatbot of a marketing application, a messaging application, or a social networking service (SNS) application used for marketing activities by related personnel of a company. Further, a screen for displaying the campaign information may be displayed via a Web browser, for example. Different display screens may be displayed by different applications, or all screens may be displayed by a single application. The display control unit 202 may be implemented by an integrated circuit such as an FPGA or an ASIC instead of a program as software.

The input unit 203 is a functional unit that receives input of an operation performed by the sales representative. The input unit 203 is implemented by the touch panel 718 illustrated in FIG. 5 and a displayed program.

Each of the functional units of the sales representative terminal 20 illustrated in FIG. 6 is a conceptual representation of a function, and is not limited to the configuration illustrated in FIG. 6. For example, a plurality of functional units illustrated as separate functional units of the sales representative terminal 20 in FIG. 6 may be configured as a single functional unit. Further, the function of any of the functional units of the sales representative terminal 20 illustrated in FIG. 6 may be divided into a plurality of functions to form a plurality of functional units.

As illustrated in FIG. 6, the job management server 31 of the print vendor 30 includes a communication unit 311, a registration unit 312, a job execution instruction unit 313, and a job information storage unit 319.

The communication unit 311 is a functional unit that transmits and receives various information to and from the print management service 55 or the printing machine 32. The communication unit 311 receives the job information including the print data delivered by the print management service 55. The communication unit 311 is implemented by the network I/F 809 and a program executed by the CPU 801 illustrated in FIG. 3, for example.

The registration unit 312 is a functional unit that registers the job information received by the communication unit 311 in the job information storage unit 319.

The job execution instruction unit 313 is a functional unit that instructs the printing machine 32 to execute the job information registered in the job information storage unit 319 in accordance with a particular schedule.

The job information storage unit 319 is a functional unit that stores the job information received by the communication unit 311. The job information storage unit 319 is implemented by at least one of the RAM 803 or the HD 804 illustrated in FIG. 3.

The registration unit 312 and the job execution instruction unit 313 are implemented by a program executed by the CPU 801 illustrated in FIG. 3, for example. Part or all of these functional units may be implemented by an integrated circuit such as an FPGA or an ASIC instead of a program as software.

Each of the functional units of the job management server 31 illustrated in FIG. 6 is a conceptual representation of a function, and is not limited to the configuration illustrated in FIG. 6. For example, a plurality of functional units illustrated as separate functional units of the job management server 31 in FIG. 6 may be configured as a single functional unit. Further, the function of any of the functional units of the job management server 31 illustrated in FIG. 6 may be divided into a plurality of functions to form a plurality of functional units.

The printing machine 32 of the print vendor 30 includes a communication unit 321 and a job execution unit 322, as illustrated in FIG. 6.

The communication unit 321 is a functional unit that transmits and receives various information to and from the job management server 31. The communication unit 321 receives an instruction to execute the job information from the job management server 31, for example. The communication unit 321 is implemented by the network I/F 950 and a program executed by the CPU 901 illustrated in FIG. 4, for example.

The job execution unit 322 is a functional unit that executes printing in accordance with the instruction to execute the job information from the job execution instruction unit 313 of the job management server 31. Specifically, the job execution unit 322 causes the printer controller 932 to print the print data included in the job information on a recording medium.

The job execution unit 322 is implemented by a program executed by the CPU 901 illustrated in FIG. 4, for example. Alternatively, the job execution unit 322 may be implemented by an integrated circuit such as an FPGA or an ASIC instead of a program as software.

Each of the functional units of the printing machine 32 illustrated in FIG. 6 is a conceptual representation of a function, and is not limited to the configuration illustrated in FIG. 6. For example, a plurality of functional units illustrated as separate functional units of the printing machine 32 in FIG. 6 may be configured as a single functional unit. Further, the function of any of the functional units of the printing machine 32 illustrated in FIG. 6 may be divided into a plurality of functions to form a plurality of functional units.

The customer terminal 40 includes a communication unit 401, a display control unit 402, and an input unit 403, as illustrated in FIG. 6.

The communication unit 401 is a functional unit that transmits and receives various information to and from the email delivery management service 56 or the LP management service 57 of the marketing support system 50. For example, the communication unit 401 receives the email data of the email delivered from the email delivery management service 56 via the mail server. When the link included in the email is pressed or the QR code on the DM is read with the image capturing device 705, the communication unit 401 transmits a request to access the URL of the LP to the LP management service 57. The communication unit 401 is implemented by the telecommunication circuit 710 and a program executed by the CPU 701 illustrated in FIG. 5, for example.

The display control unit 402 is a functional unit that controls a display operation of the display 715 of the customer terminal 40. For example, the display control unit 402 causes the display 715 to display the email data of the email received by the communication unit 401.

The input unit 403 is a functional unit that receives input of an operation performed by the customer. The input unit 403 is implemented by the touch panel 718 illustrated in FIG. 5.

The display control unit 402 is implemented by a program executed by the CPU 701 illustrated in FIG. 5, for example. Alternatively, the display control unit 402 may be implemented by an integrated circuit such as an FPGA or an ASIC instead of a program as software.

Each of the functional units of the customer terminal 40 illustrated in FIG. 6 is a conceptual representation of a function, and is not limited to the configuration illustrated in FIG. 6. For example, a plurality of functional units illustrated as separate functional units of the customer terminal 40 in FIG. 6 may be configured as a single functional unit. Further, the function of any of the functional units of the customer terminal 40 illustrated in FIG. 6 may be divided into a plurality of functions to form a plurality of functional units.

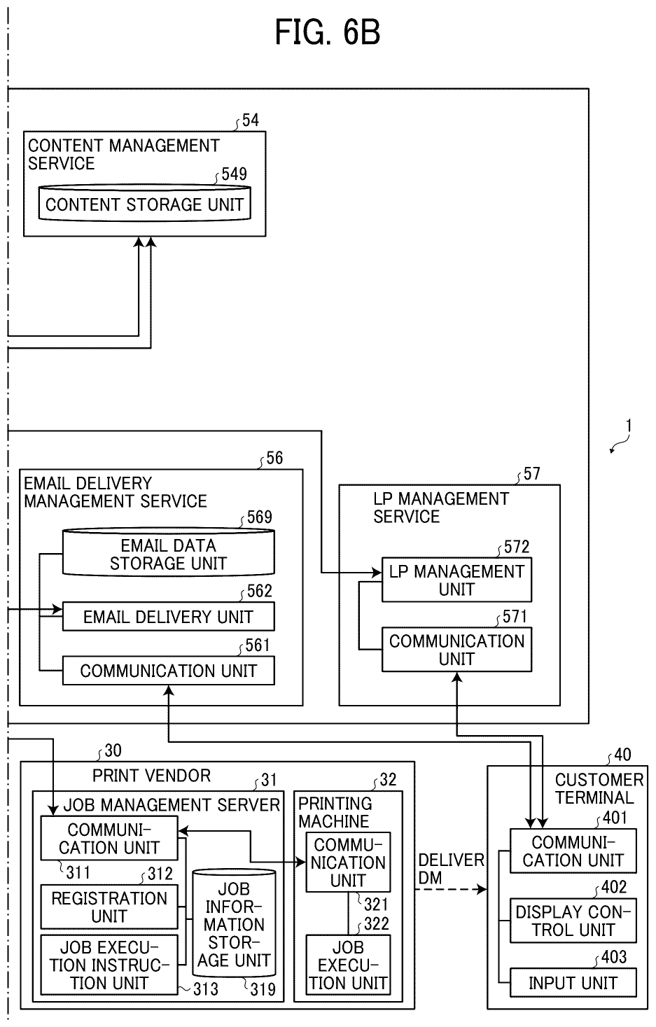

FIG. 7 is a diagram illustrating an exemplary data model used in the equipment system 1 of the embodiment. A data model used in the equipment system 1 of the embodiment will be described with reference to FIG. 7. In FIG. 7, the ID of data in each class is omitted. To enable the tracking of data between classes connected by connection lines, the data of a certain class may be assigned with the ID of the data of another class connected to the certain class by a connection line, or a table for registering the relationships between data items may be prepared. For example, a campaign ID and a customer ID may be held in the data of access information to make campaign data and customer data identifiable.

The campaign management service 51 includes information related to the campaign (information included in the campaign information stored in the storage unit 519), which includes “name” (the name of the campaign), “type” (DM or email), “start date,” and “status.”

In the information related to the campaign, “status” is information indicating the progress of the campaign executed based on the campaign information, and “start date” indicates the date when the creation of the campaign is completed or the date when the campaign is executed based on the created campaign information.

The campaign management service 51 further includes information related to the action (information included in the action information stored in the storage unit 519), which includes “type” (DM or email).

The campaign management service 51 further includes information related to the variable data (information stored in the storage unit 519), which includes “variable name” and “value.”

The campaign management service 51 further includes access information (information stored in the storage unit 519), which includes “access date” and “error information.”

In the access information, “access date” indicates the date of access to the LP from the customer terminal 40, and “error information” is information indicating unsuccessful transmission of the email to the customer terminal 40 or unsuccessful delivery of the DM to the customer, for example.

The user management service 52 includes information of the user (the user information stored in the user information storage unit 529), which includes “name” and “email address.” The user is the marketing representative or the sales representative, for example.

The customer management service 53 includes information related to the customer (the customer information stored in the customer information storage unit 539), which includes “company name,” “customer name,” “email address,” “phone,” and “address.”

The content management service 54 includes information of the template to be included in the DM or email that is delivered to the customer (information stored in the content storage unit 549). The information of the template includes “name” (the name of the template), “type” (DM or email), “template file,” and “LP template file.”

In the information of the template, “template file” is a file of a template as an entity to be included in the DM or email that is delivered to the customer. Further, “LP template file” is a file of a template as an entity for forming the Web page of the LP in response to the access request from the customer terminal 40.

The content management service 54 further includes information related to variables included in the above-described templates and replaced by the variable data (information stored in the content storage unit 549). The information related to the variables includes “variable name” and “type.”

The print management service 55 includes information related to scheduled print, which includes “shipping date” and “print data.”

The email delivery management service 56 includes information related to scheduled email transmission (information stored in the email data storage unit 569), which includes “transmission date” and “email data.”

The LP management service 57 includes information related to the link to the LP, which includes the URL indicating the location of the Web page of the LP.

The LP management service 57 further includes information related to the Web site, which includes “host name” and “port.”

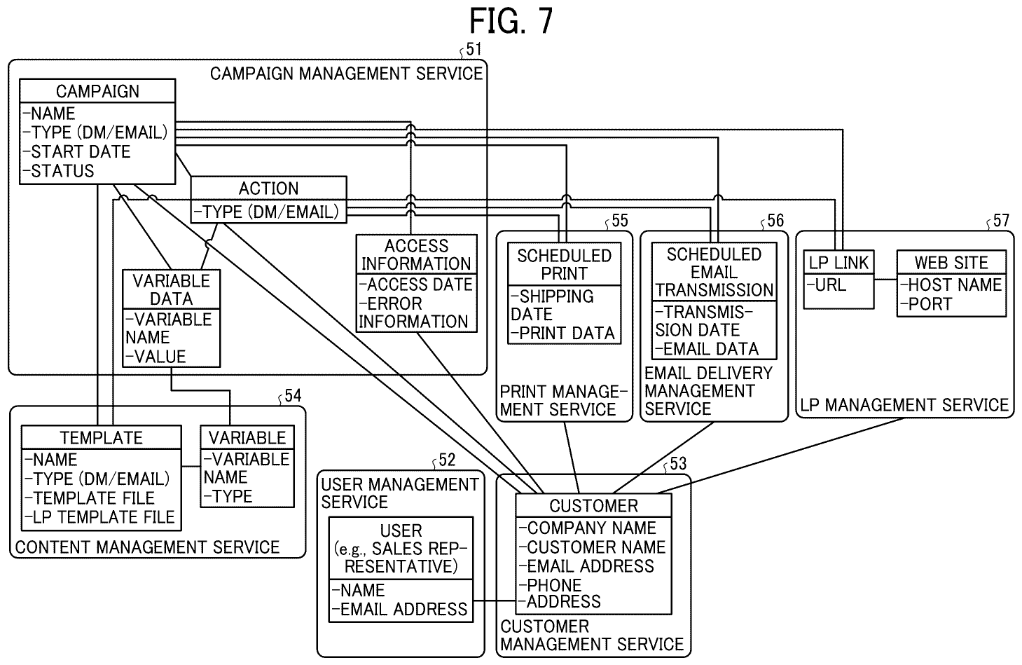

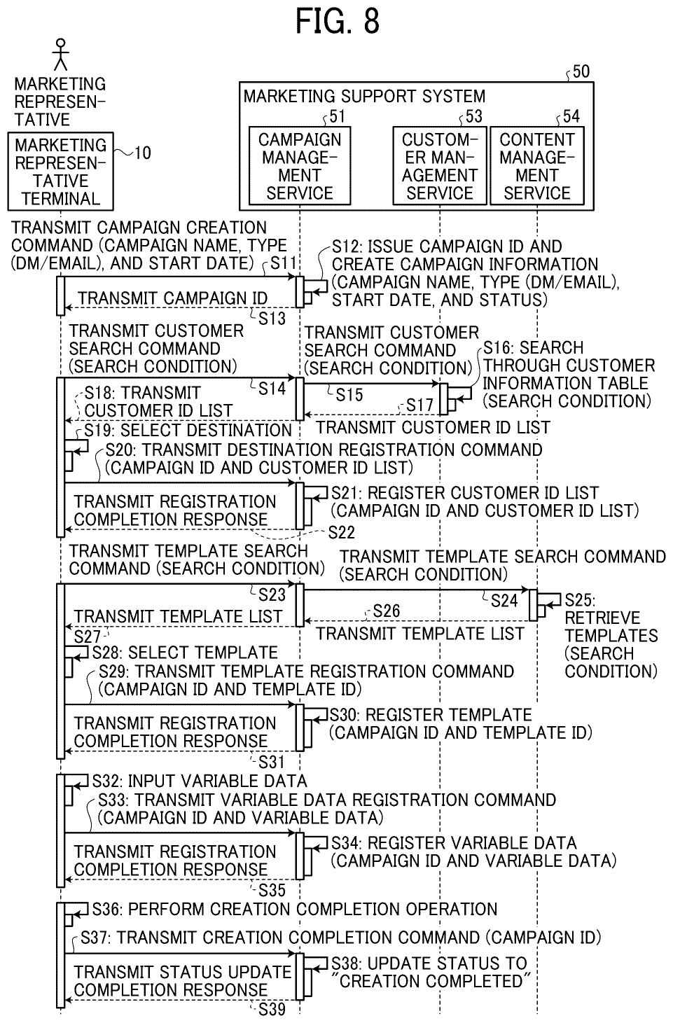

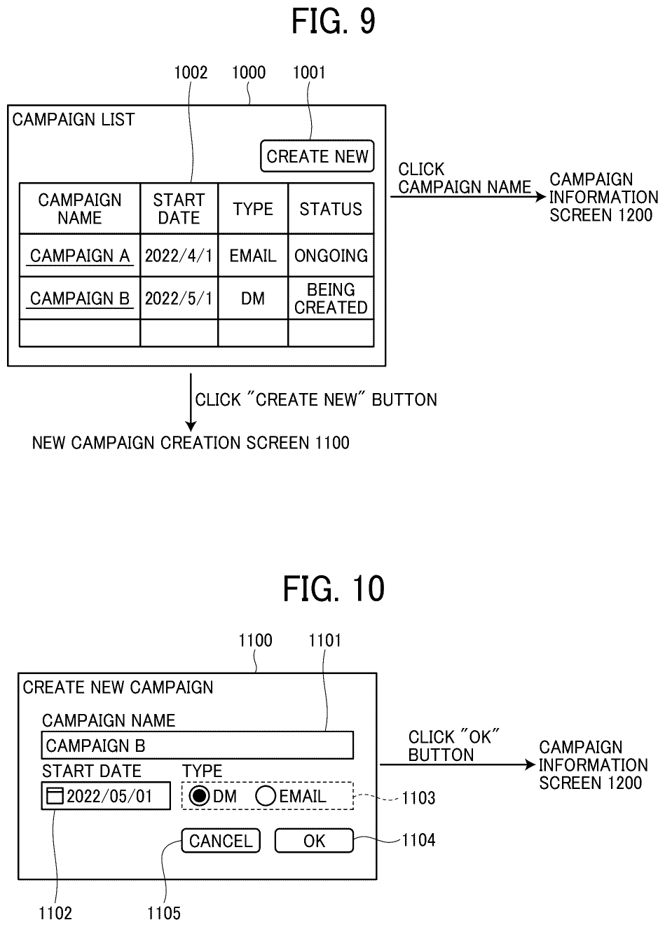

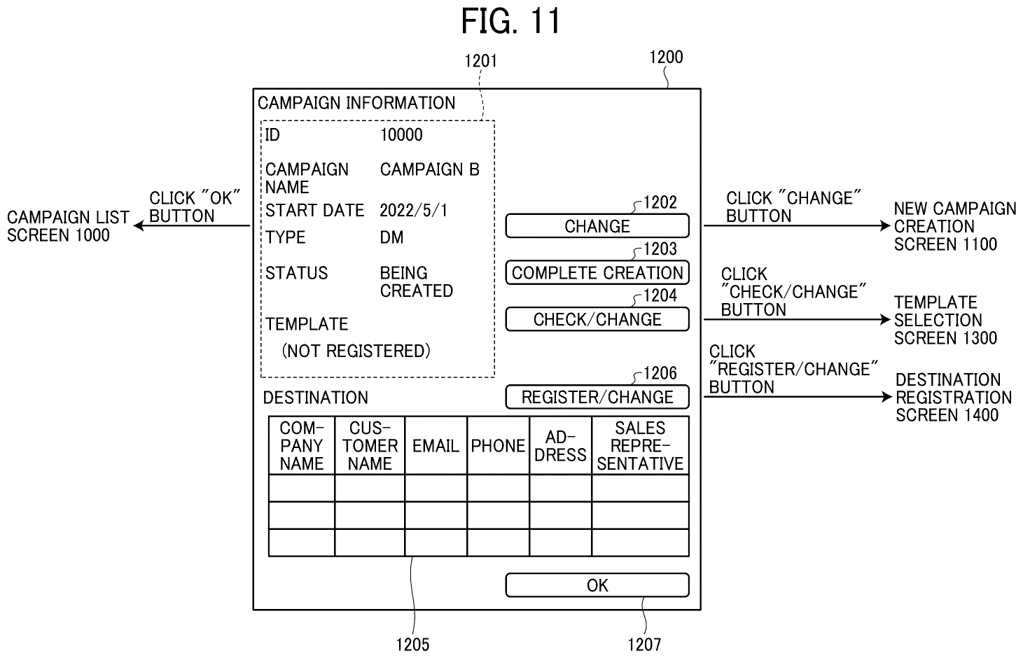

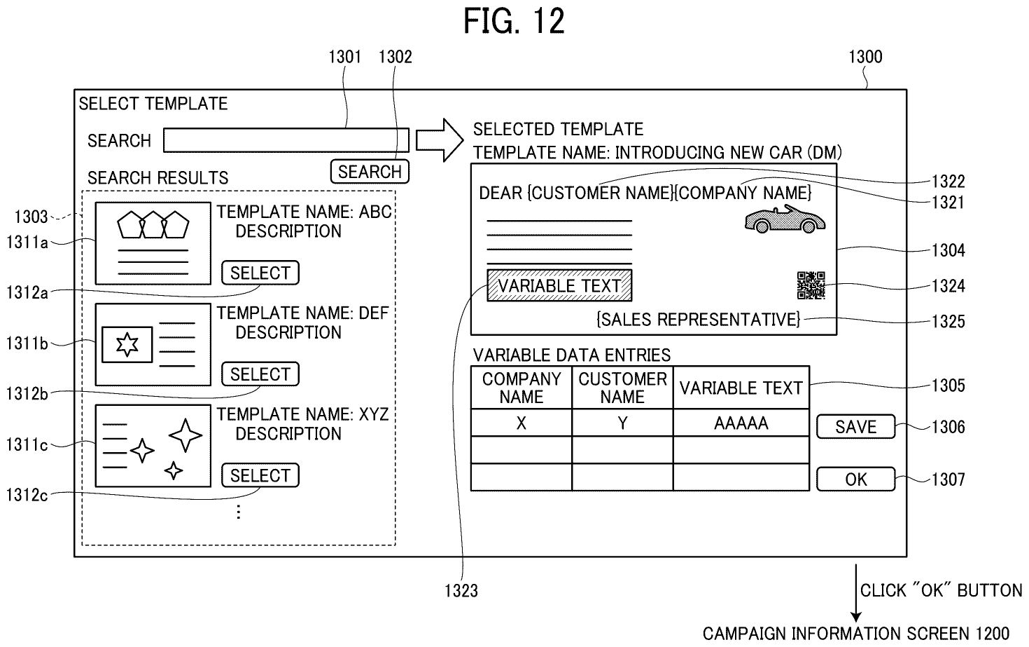

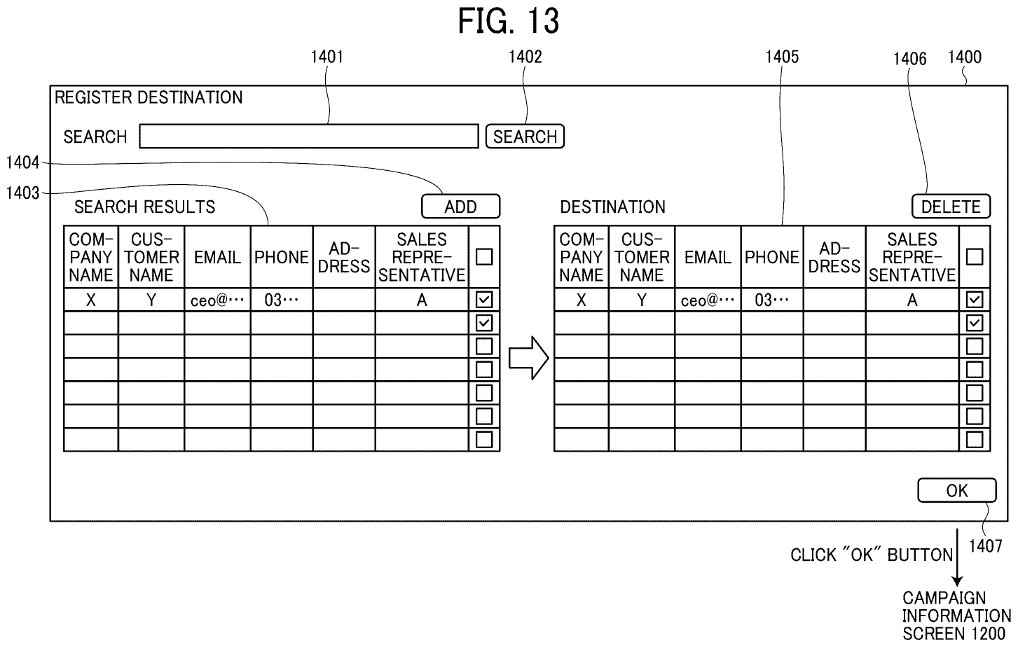

FIG. 8 is a sequence diagram illustrating an exemplary procedure of a campaign registration process in the equipment system 1 of the embodiment. FIG. 9 is a diagram illustrating an example of a campaign list screen. FIG. 10 is a diagram illustrating an example of a new campaign creation screen. FIG. 11 is a diagram illustrating an example of a campaign information screen. FIG. 12 is a diagram illustrating an example of a template selection screen. FIG. 13 is a diagram illustrating an example of a destination registration screen. A procedure of the campaign registration process in the equipment system 1 of the embodiment will be described with reference to FIGS. 8 to 13.

At step S11, the marketing representative first operates the input unit 103 of the marketing representative terminal 10 to display the campaign list screen 1000 illustrated in FIG. 9.

The campaign list screen 1000 illustrated in FIG. 9 is a screen that displays a list of created campaigns. The campaign list screen 1000 includes a CREATE NEW button 1001 and a campaign list display area 1002.

The CREATE NEW button 1001 is a button for newly creating a campaign. When the CREATE NEW button 1001 is pressed, the campaign list screen 1000 transitions to the later-described new campaign creation screen 1100 illustrated in FIG. 10.

The campaign list display area 1002 is a display area that displays a list of created campaigns. Specifically, the campaign list display area 1002 displays the campaign name, the start date, the type indicating email or DM, and the status for each of the created campaigns. When the campaign name of the intended campaign is selected (e.g., clicked) from the list of campaigns displayed in the campaign list display area 1002, the campaign list screen 1000 transitions to a later-described campaign information screen 1200 illustrated in FIG. 11, which displays the content of the campaign. The marketing representative views the campaign list display area 1002 of the campaign list screen 1000 and checks the “STATUS” of the created campaign to recognize the progress of the campaign.

The marketing representative then presses the CREATE NEW button 1001 of the campaign list screen 1000, and the display control unit 102 of the marketing representative terminal 10 causes the display 806 to display the new campaign creation screen 1100 illustrated in FIG. 10.

The new campaign creation screen 1100 illustrated in FIG. 10 is a screen for newly creating a campaign. The new campaign creation screen 1100 includes a campaign name input field 1101, a start date input field 1102, a type selection field 1103, an OK button 1104, and a CANCEL button 1105.

The campaign name input field 1101 is a field for setting and inputting the campaign name of the campaign to be newly created.

The start date input field 1102 is a field for setting and inputting the start date of starting executing the campaign to be newly created.

The type selection field 1103 is a field for selecting DM or email as a method of delivering the campaign information to the customer.

The OK button 1104 is a button for creating the campaign information with the settings input in the campaign name input field 1101, the start date input field 1102, and the type selection field 1103. When the OK button 1104 is pressed, the new campaign creation screen 1100 transitions to the later-described campaign information screen 1200 illustrated in FIG. 11.

The CANCEL button 1105 is a button for canceling the creation of a new campaign. When the CANCEL button 1105 is pressed, the new campaign creation screen 1100 transitions to the campaign list screen 1000.

The marketing representative then sets and inputs the campaign name and the start date in the campaign name input field 1101 and the start date input field 1102, respectively, selects the type in the type selection field 1103, and presses the OK button 1104 on the new campaign creation screen 1100. Then, the communication unit 101 of the marketing representative terminal 10 transmits a campaign creation command to the campaign management service 51 of the marketing support system 50. The campaign creation command includes the campaign name, the type, and the start date set on the new campaign creation screen 1100. Further, the display control unit 102 of the marketing representative terminal 10 transitions the new campaign creation screen 1100 to the campaign information screen 1200 illustrated in FIG. 11.

The campaign information screen 1200 illustrated in FIG. 11 is a screen displaying details of the campaign information. The campaign information screen 1200 includes a campaign information display area 1201, a CHANGE button 1202, a COMPLETE CREATION button 1203, a CHECK/CHANGE button 1204, a destination display area 1205, a REGISTER/CHANGE button 1206, and an OK button 1207.

The campaign information display area 1201 is an area that displays the campaign ID, the campaign name, the start date, the type, the status, and the template included in the campaign information.

The CHANGE button 1202 is a button for transitioning to the new campaign creation screen 1100 to change the campaign name, the start date, or the type.

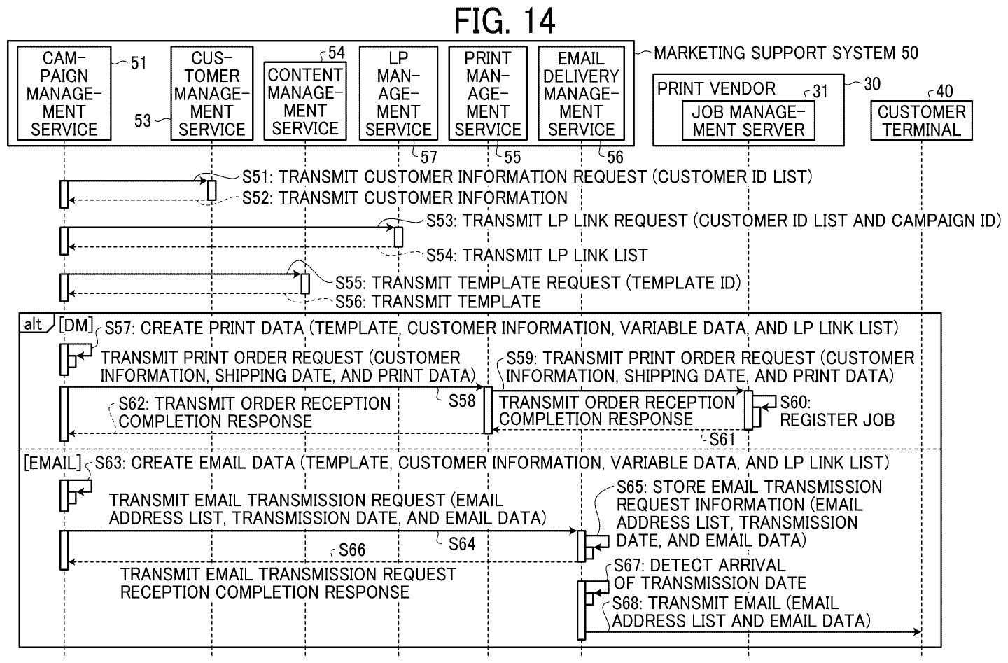

The COMPLETE CREATION button 1203 is a button for completing the creation of the campaign information that specifies the new campaign. When the COMPLETE CREATION button 1203 is pressed, the content of the campaign information is confirmed, and the status of the campaign information changes to “CREATION COMPLETED.” Then, the process illustrated in FIG. 14 starts.

The CHECK/CHANGE button 1204 is a button for selecting or changing the template to be included in the DM or email. When the CHECK/CHANGE button 1204 is pressed, the campaign information screen 1200 transitions to a later-described template selection screen 1300 illustrated in FIG. 12.

The destination display area 1205 is an area displaying the registered destination of the customer to whom the DM or email is to be delivered.

The REGISTER/CHANGE button 1206 is a button for selecting or changing the destination of the customer to whom the DM or email is to be delivered. When the REGISTER/CHANGE button 1206 is pressed, the campaign information screen 1200 transitions to a later-described destination registration screen 1400 illustrated in FIG. 13. The OK button 1207 is a button for transitioning to the campaign list screen 1000.

The marketing representative views the campaign information display area 1201 of the campaign information screen 1200 and checks the “STATUS” of the displayed campaign to recognize the progress of the campaign.

At step S12 in FIG. 8, when the communication unit 511 of the campaign management service 51 receives the campaign creation command from the marketing representative terminal 10, the campaign creation unit 513 of the campaign management service 51 issues a campaign ID and creates campaign information including the campaign ID, the campaign name, the type, and the start date included in the campaign creation command, and a status “BEING CREATED.” The campaign creation unit 513 then stores the created campaign information in the storage unit 519. At this point, the campaign information has been newly created, but items such as the template and the destination are yet to be set, as described later. Therefore, the status of the campaign information at this point is “BEING CREATED.”

At step S13, the campaign creation unit 513 transmits the issued campaign ID to the marketing representative terminal 10 via the communication unit 511 as a response to the campaign creation command from the marketing representative terminal 10.

At step S14, the marketing representative presses the REGISTER/CHANGE button 1206 of the campaign information screen 1200 to select the destination of the customer to whom the DM or email is to be delivered. Then, the display control unit 102 transitions the campaign information screen 1200 to the destination registration screen 1400 illustrated in FIG. 13.

The destination registration screen 1400 illustrated in FIG. 13 is a screen for selecting the destination of the customer to whom the DM or email is to be delivered. The destination registration screen 1400 includes a search text input field 1401, a SEARCH button 1402, a search result display area 1403, an ADD button 1404, a registered destination display area 1405, a DELETE button 1406, and an OK button 1407.

The search text input field 1401 is a field for inputting a keyword for retrieving the customer information of the destination from the customer information stored in the customer information storage unit 539 of the customer management unit 53.

The search button 1402 is a button for retrieving the customer information of the destination from the customer information stored in the customer information storage unit 539 of the customer management service 53 based on the keyword input in the search text input field 1401 as a search condition.

The search result display area 1403 is an area displaying the customer information of the destination retrieved in response to the pressing of the SEARCH button 1402. In the example illustrated in FIG. 13, the search result display area 1403 displays company name, customer name, email (email address), phone (phone number), and sales representative as the customer information.

The ADD button 1404 is a button for registering the customer information displayed in the search result display area 1403 and checked in the corresponding checkbox as the customer information to be included in the campaign information. When the ADD button 1404 is pressed, the customer information checked in the search result display area 1403 is displayed in the registered destination display area 1405, and the customer ID of the customer information is registered in the campaign information. The customer information displayed in the registered destination display area 1405 is reflected in the destination display area 1205 of the campaign information screen 1200 in FIG. 11.

The registered destination display area 1405 is an area displaying, as the customer information of the destination, the customer information with the customer ID thereof registered in the campaign information.

The DELETE button 1406 is a button for deleting the customer information displayed in the registered destination display field 1405 and checked in the corresponding checkbox. Specifically, when the DELETE button 1406 is pressed, the customer ID of the customer information checked in the corresponding checkbox is deleted from the campaign information.

The OK button 1407 is a button for transitioning to the campaign information screen 1200.

The marketing representative then inputs a keyword in the search text input field 1401 and presses the SEARCH button 1402 on the destination registration screen 1400. Then, the communication unit 101 of the marketing representative terminal 10 transmits to the campaign management service 51 a customer search command including the keyword as a search condition.

At step S15, when the communication unit 511 of the campaign management service 51 receives the customer search command from the marketing representative terminal 10, the destination selection unit 514 of the campaign management service 51 transmits the customer search command to the customer management service 53.

At step S16, the customer management service 53 receives the customer search command from the campaign management service 51 and retrieves customer information items satisfying the search condition included in the customer search command from a customer information table stored in the customer information storage unit 539.

At step S17, the customer management service 53 then transmits a list of customer IDs of the retrieved customer information items to the campaign management service 51. It is assumed here that, as well as the customer IDs, the entire customer information items are transmitted to the campaign management service 51.

At step S18, the destination selection unit 514 receives the list of customer IDs from the customer management service 53 and transmits the list of customer IDs to the marketing representative terminal 10 via the communication unit 511.

At step S19, when the communication unit 101 of the marketing representative terminal 10 receives the list of customer IDs (a list of entire customer information items in this case), the display control unit 102 of the marketing representative terminal 10 displays the received list in the search result display area 1403 of the destination registration screen 1400 as a list of customer information items. The marketing representative checks the checkbox of a desired customer information item to select the customer information item from the list of customer information items displayed in the search result display area 1403, and presses the ADD button 1404 in FIG. 13.

In the example of FIG. 13, customers are selected individually. However, the selection is not limited to this example. For example, a group of customers, such as a group of customers belonging to the same company, may be selected.

At step S20, the communication unit 101 transmits a destination registration command to the campaign management service 51. The destination registration command includes the campaign ID and a list of customer IDs of customers as the destinations checked in the checkboxes of the search result display area 1403. The communication unit 101 may transmit the destination registration command to the campaign management service 51 when the OK button 1407 is pressed after the information of a certain destination checked in the search result display area 1403 is added to the registered destination display area 1405 with the ADD button 1404 or a certain destination checked in the registered destination display area 1405 is deleted with the DELETE button 1406. In this case, the destination registration command includes the campaign ID and the list of customer IDs of the customers as the destinations checked in the checkboxes of the registered destination display area 1405.

At step S21, when the communication unit 511 receives the destination registration command, the destination selection unit 514 registers the list of customer IDs included in the destination registration command into the campaign information created in the storage unit 519 and including a campaign ID matching the campaign ID included in the destination registration command.

At step S22, the destination selection unit 514 transmits a registration completion response to the marketing representative terminal 10 via the communication unit 511. The registration completion response indicates that the list of customer IDs has been registered in the campaign information. When the communication unit 101 of the marketing representative terminal 10 receives the registration completion response, the display control unit 102 of the marketing representative terminal 10 displays, in the registered destination display area 1405, the customer information items of the destinations checked in the checkboxes of the search result display area 1403. Thereby, the marketing representative is able to recognize that the customer information items selected as the destinations in the search result display area 1403 have been registered in the campaign management service 51. The marketing representative then presses the OK button 1407 to transition to the campaign information screen 1200.

At step S23, the marketing representative presses the CHECK/CHANGE button 1204 of the campaign information screen 1200 to select the template to be included in the DM or email. Then, the display control unit 102 transitions the campaign information screen 1200 to the template selection screen 1300 illustrated in FIG. 12.

The template selection screen 1300 illustrated in FIG. 12 is a screen for selecting the template to be included in the DM or email. The template selection screen 1300 includes a search text input field 1301, a SEARCH button 1302, a search result display area 1303, a selected template 1304, a variable data input field 1305, a SAVE button 1306, and an OK button 1307.

The search text input field 1301 is a field for inputting a keyword for retrieving a desired template from the templates stored in the content storage unit 549 of the content management service 54.

The SEARCH button 1302 is a button for retrieving the desired template from the templates stored in the content storage unit 549 of the content management service 54 based on the keyword input in the search text input field 1301 as a search condition.

The search result display area 1303 is an area displaying a list of content items retrieved from the content stored in the content storage unit 549 as content items satisfying the search condition input in the search text input field 1301. In the example illustrated in FIG. 12, the search result display area 1303 displays search result templates 1311a, 1311b, and 1311c as the retrieved templates. SELECT buttons 1312a, 1312b, and 1312c are buttons for selecting the search result templates 1311a, 1311b, and 1311c, respectively. When one of the SELECT buttons 1312a to 1312c is pressed, the corresponding one of the search result templates 1311a to 1311c is displayed as the selected template 1304.

The selected template 1304 is the template selected from the templates displayed in the search result display area 1303. In the example illustrated in FIG. 12, the selected template 1304 includes variable data insertion fields 1321, 1322, and 1323, a QR code placement area 1324, and a sales representative name insertion field 1325.

The variable data insertion field 1321 is a field for inserting the company name of the variable data input in the variable data input field 1305. The variable data insertion field 1322 is a field for inserting the customer name of the variable data input in the variable data input field 1305. The variable data insertion field 1323 is a field for inserting the variable text of the variable data input in the variable data input field 1305.

The QR code placement area 1324 is an area for placing a QR code generated in a later-described marketing data generation process by the marketing data generation unit 518. The sales representative name insertion field 1325 is a field for inserting the name of the sales representative.

The variable data input field 1305 is a field for inputting the variable data to be inserted in the selected template 1304. In the example illustrated in FIG. 12, it is possible to input the company name, the customer name, and the variable text in the variable data input field 1305 as the variable data. The variable data is not limited to the items illustrated in FIG. 12, and any other variable data item may be set and input in the variable data input field 1305. Further, the company name and the customer name registered in the destination display area 1205 of the campaign information screen 1200 may be automatically input in the company name and the customer name of the variable data input field 1305. In this case, the company name and the customer name of the variable data input field 1305 may be made editable.

The SAVE button 1306 is a button for registering and storing the variable data input in the variable data input field 1305 into the campaign information stored in the storage unit 519 of the campaign management service 51.

The OK button 1307 is a button for transitioning to the campaign information screen 1200.

The marketing representative then inputs a keyword in the search text input field 1301 and presses the SEARCH button 1302 on the template selection screen 1300. Then, the communication unit 101 transmits to the campaign management service 51 a template search command including the keyword as a search condition.

At step S24, when the communication unit 511 of the campaign management service 51 receives the template search command from the marketing representative terminal 10, the template selection unit 515 of the campaign management service 51 transmits the template search command to the content management service 54.

At step S25, in response to receipt of the template search command from the campaign management service 51, the content management service 54 retrieves templates satisfying the search condition included in the template search command from the content stored in the content storage unit 549.

At step S26, the content management service 54 transmits a list of retrieved templates to the campaign management service 51.

At step S27, in response to receipt of the list of templates from the content management service 54, the template selection unit 515 transmits the list of templates to the marketing representative terminal 10 via the communication unit 511.

At step S28, when the communication unit 101 of the marketing representative terminal 10 receives the list of templates, the display control unit 102 of the marketing representative terminal 10 displays the list of templates in the search result display area 1303 of the template selection screen 1300. The marketing representative selects a desired template from the list of templates displayed in the search result display area 1303 by pressing the selection button corresponding to the desired template (i.e., the SELECT button 1312a, 1312b, or 1312c illustrated in FIG. 12).

At step S29, the communication unit 101 transmits to the campaign management service 51 a template registration command including the campaign ID and the template ID of the template selected in accordance with the pressing of the selection button in the search result display area 1303.

At step S30, when the communication unit 511 receives the template registration command, the template selection unit 515 registers the template ID included in the template registration command into the campaign information created in the storage unit 519 and including a campaign ID matching the campaign ID included in the template registration command.

At step S31, the template selection unit 515 transmits a registration completion response to the marketing representative terminal 10 via the communication unit 511. The registration completion response indicates that the template has been registered in the campaign information. When the communication unit 101 receives the registration completion response, the display control unit 102 displays the template selected in the search result display area 1303 as the selected template 1304. Thereby, the marketing representative recognizes that the template selected in the search result display area 1303 has been registered in the campaign management service 51. If the selection button corresponding to a different template is pressed in the search result display area 1303, the template registered in the campaign information is updated with the different template.

At step S32, the marketing representative inputs the variable data in the variable data input field 1305 to set the variable data to be inserted in the variable data insertion fields 1321 to 1323 of the selected template 1304.

The setting of the variable data is not limited to the input of text, and may also include the specification of an image (e.g., bitmap image) or the specification of a link, for example.

At step S33, the marketing representative presses the SAVE button 1306, and the communication unit 101 transmits to the campaign management service 51 a variable data registration command including the variable data input in the variable data input field 1305 and the campaign ID.

At step S34, when the communication unit 511 receives the variable data registration command, the variable data registration unit 516 registers the variable data included in the variable data registration command into the campaign information created in the storage unit 519 and including a campaign ID matching the campaign ID included in the variable data registration command.

At step S35, the variable data registration unit 516 transmits a registration completion response to the marketing representative terminal 10 via the communication unit 511. The registration completion response indicates that the variable data has been registered in the campaign information. The marketing representative then presses the OK button 1307 to transition to the campaign information screen 1200.

At step S36, the information to be registered in the campaign information to start the campaign has been registered, and thus the marketing representative presses the COMPLETE CREATION button 1203.

At step S37, the communication unit 101 transmits to the campaign management service 51 a creation completion command including the campaign ID displayed in the campaign information display area 1201.

At step S38, when the communication unit 511 receives the creation completion command, the campaign creation unit 513 updates the status of the campaign information created in the storage unit 519 and including a campaign ID matching the campaign ID included in the creation completion command to “CREATION COMPLETED” from “BEING CREATED.”

At step S39, the campaign creation unit 513 transmits a status update completion response to the marketing representative terminal 10 via the communication unit 511. The status update completion response indicates that the status of the campaign information has been updated to “CREATION COMPLETED.”

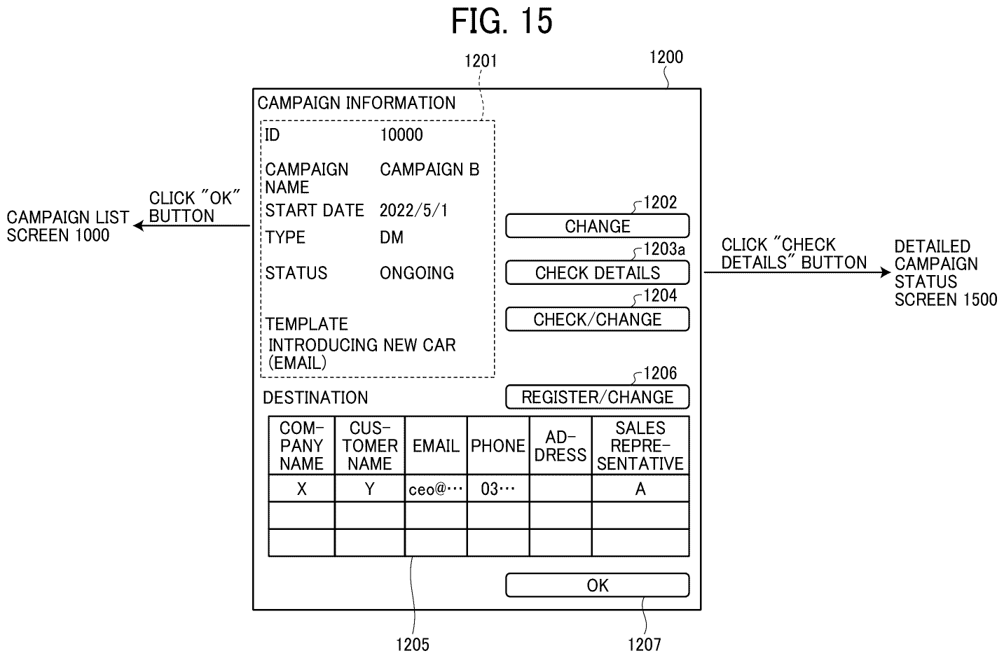

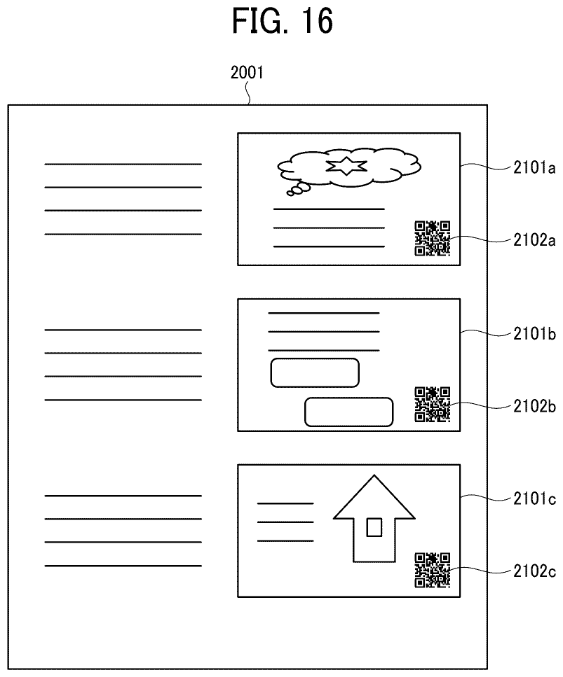

FIG. 14 is a sequence diagram illustrating an exemplary procedure of a campaign start process in the equipment system 1 of the embodiment. FIG. 15 is a diagram illustrating an example of the campaign information screen 1200 when the campaign is ongoing. FIG. 16 is a diagram illustrating an example of the DM to be delivered to the customer. A procedure of the campaign start process in the equipment system 1 of the embodiment will be described with reference to FIGS. 14 to 16.

At step S51, the campaign execution management unit 517 of the campaign management service 51 starts the campaign when the status of the campaign information created in the storage unit 519 changes to “CREATION COMPLETED” (when the COMPLETE CREATION button 1203 is pressed). In this case, the start date of the campaign is the same as the shipping date of the DM or the transmission date of the email. The completion of the campaign creation is immediately followed by the ordering of the DM with the print vendor 30 (later-described steps S58 and S59) or the scheduled email transmission (later-described steps S64 and S65). When the campaign creation is completed, the campaign execution management unit 517 leaves the status of the campaign as “CREATION COMPLETED.” Then, when the start date of the campaign information arrives, the campaign execution management unit 517 changes the status of the campaign to “ONGOING.” As another method of starting the campaign, the campaign execution management unit 517 may monitor whether or not the preset start date of the campaign information has arrived. Then, when the start date of the campaign information arrives, the campaign execution management unit 517 may start the campaign. In this case, the campaign execution management unit 517 updates the status included in the campaign information to “ONGOING” from “CREATION COMPLETED,” and starts the campaign based on the campaign information. Specifically, as the process immediately following the completion of the campaign creation (i.e., the campaign start process), the campaign execution management unit 517 first transmits to the customer management service 53 a customer information request including the list of customer IDs included in the campaign information. When the status of the campaign information is updated to “ONGOING” by the campaign execution management unit 517, the “STATUS” in the campaign information display area 1201 is displayed as “ONGOING,” as in the campaign information screen 1200 illustrated in FIG. 15. Further, the COMPLETE CREATION button 1203 of the campaign information screen 1200 illustrated in FIG. 11 changes to a CHECK DETAILS button 1203a. The change from the COMPLETE CREATION button 1203 to the CHECK DETAILS button 1203a, however, is not limited to the above-described timing. For example, the COMPLETE CREATION button 1203 may change to the CHECK DETAILS button 1203a when the COMPLETE CREATION button 1203 is pressed at step S36 and the status update completion response is received by the marketing representative terminal 10 at step S39 in FIG. 8. Further, the start of the campaign based on the campaign information is not limited to the above-described timing when the campaign creation is completed or the start date arrives. For example, the campaign may be started when the marketing representative performs a particular operation on the marketing representative terminal 10.

The CHECK DETAILS button 1203a is a button for transitioning to a later-described detailed campaign status screen 1500 that displays a detailed status of the started campaign.

At step S52, in response to receipt of the customer information request from the campaign management service 51, the customer management service 53 extracts, from the customer information table stored in the customer information storage unit 539, the customer information corresponding to the list of customer IDs included in the customer information request. The customer management service 53 then transmits the extracted customer information to the campaign management service 51.

At step S53, the campaign execution management unit 517 transmits to the LP management service 57 an LP link request including the campaign ID and the list of customer IDs included in the campaign information.

At step S54, in response to receipt of the LP link request from the campaign management service 51, the LP management unit 572 of the LP management service 57 transmits to the campaign management service 51 a list of LP links corresponding to the customer IDs in the list of customer IDs included in the LP link request. Herein, the LP management unit 572 may create each of the LP links with the campaign ID and the corresponding customer ID included in the LP link request. For example, the LP management unit 572 may create the LP link including an encrypted character string of the campaign ID and the customer ID. Alternatively, the LP management unit 572 may generate a character string to be included in the LP link with random numbers and store the generated character string in a database in association with the campaign ID and the customer ID.

At step S55, the campaign execution management unit 517 transmits to the content management service 54 a template request including the template ID included in the campaign information.

At step S56, in response to receipt of the template request from the campaign management service 51, the content management service 54 extracts, from the content stored in the content storage unit 549, the template corresponding to the template ID included in the template request. The content management service 54 then transmits the extracted template to the campaign management service 51.

If the type included in the campaign information is DM, the procedure proceeds to step S57. If the type is email, the procedure proceeds to step S63.

At step S57, the marketing data generation unit 518 creates the print data of the DM (an example of first marketing data) with the template included in the campaign information, the customer information, the variable data, and the list of LP inks (first URL information). The template (a first template) and the variable data are examples of first content. In this case, the marketing data generation unit 518 generates QR codes and includes the generated QR codes in the print data. Each of the QR codes includes the corresponding customer ID and the campaign ID included in the campaign information and the corresponding LP link. FIG. 16 illustrates the DM 2001 as an example of the DM printed with the print data created by the campaign execution management unit 517. The marketing data (e.g., the first marketing data or second marketing data) may be created with content and customers selected in accordance with an instruction from an information terminal (i.e., the first information terminal or the second information terminal). The first marketing data may be automatically created with content previously set on the information terminal in response to the completion of the creation of the campaign information or the start of the campaign.

The DM 2001 illustrated in FIG. 16 is an example of a DM including multiple sets of templates and QR codes. The DM 2001 includes templates 2101a, 2101b, and 2101c and QR codes 2102a, 2102b, and 2102c. The DM, however, is not necessarily required to include multiple sets of templates and QR codes, and may include a single set of a template and a QR code.

The templates 2101a to 2101c are the templates selected and registered on the template selection screen 1300. Each of the templates 2101a to 2101c displays the variable data input on the template selection screen 1300. The QR codes generated by the campaign execution management unit 517 are placed as the QR codes 2102a to 2102c. The QR codes placed on the DM, however, may be replaced by another type of two-dimensional codes.

At step S58, the campaign execution management unit 517 transmits a print order request to the print management service 55. The print order request includes the customer information including the addresses of the customers, the shipping date included in the campaign information, and the print data. The shipping date is, for example, the shipping date set on the new campaign creation screen 1100, as described above.

At step S59, in response to receipt of the print order request from the campaign management service 51, the print request unit 552 of the print management service 55 transmits the print order request to the job management server 31 of the print vendor 30 via the communication unit 551.

At step S60, when the communication unit 311 of the job management server 31 receives the print order request from the print management service 55, the registration unit 312 of the job management server 31 registers the print order request in the job information storage unit 319 as the job information.

At step S61, the registration unit 312 transmits an order reception completion response to the print management service 55 via the communication unit 311. The order reception completion response indicates that the print order has been received.

Then, in accordance with an operation performed by the print vendor 30, the job execution instruction unit 313 of the job management server 31 instructs the printing machine 32 to execute the job information registered in the job information storage unit 319 with appropriate timing. In accordance with the job information execution instruction from the job execution instruction unit 313 of the job management server 31, the job execution unit 322 executes the printing of the DM (an example of a first medium). Then, the print vendor ships and delivers the DM in accordance with the shipping date indicated by the job information. In this case, the delivery destination of the DM is the addresses indicated by the customer information included in the job information.

At step S62, in response to receipt of the order reception completion response from the job management server 31 via the communication unit 551, the print request unit 552 transmits the order reception completion response to the campaign management service 51.

At step S63, the marketing data generation unit 518 creates the email data of the email (an example of the first marketing data) with the template included in the campaign information, the customer information, the variable data, and the list of LP inks (the first URL information). The template and the variable data are examples of the first content. In this case, the marketing data generation unit 518 generates links each including the customer ID and the campaign ID included in the campaign information and the LP link, and includes the generated links in the email data. The LP link included in the link (the QR code) together with the customer ID is an example of the first URL information according to the customer.

At step S64, the campaign execution management unit 517 transmits an email transmission request to the email delivery management service 56. The email transmission request includes a list of email addresses included in the customer information, the transmission date included in the campaign information, and the email data. The transmission date may be, for example, the transmission date set on the new campaign creation screen 1100, as described above, or may be the start date of the campaign.

At step S65, in response to receipt of the email transmission request from the campaign management service 51, the email delivery unit 562 of the email delivery management service 56 registers (stores) the information of the email transmission request in the email data storage unit 569 to schedule email transmission.

At step S66, the email delivery unit 562 transmits an email transmission request reception completion response to the campaign management service 51. The email transmission request reception completion response indicates that the email transmission request has been received.

At step S67, the email delivery unit 562 detects that the transmission date indicated by the email transmission request registered in the email data storage unit 569 has arrived.

At step S68, the email delivery unit 562 transmits (delivers) the email (an example of the first medium) formed with the email data included in the email transmission request to the email addresses included in the email transmission request. The customer terminal 40 then receives the email.

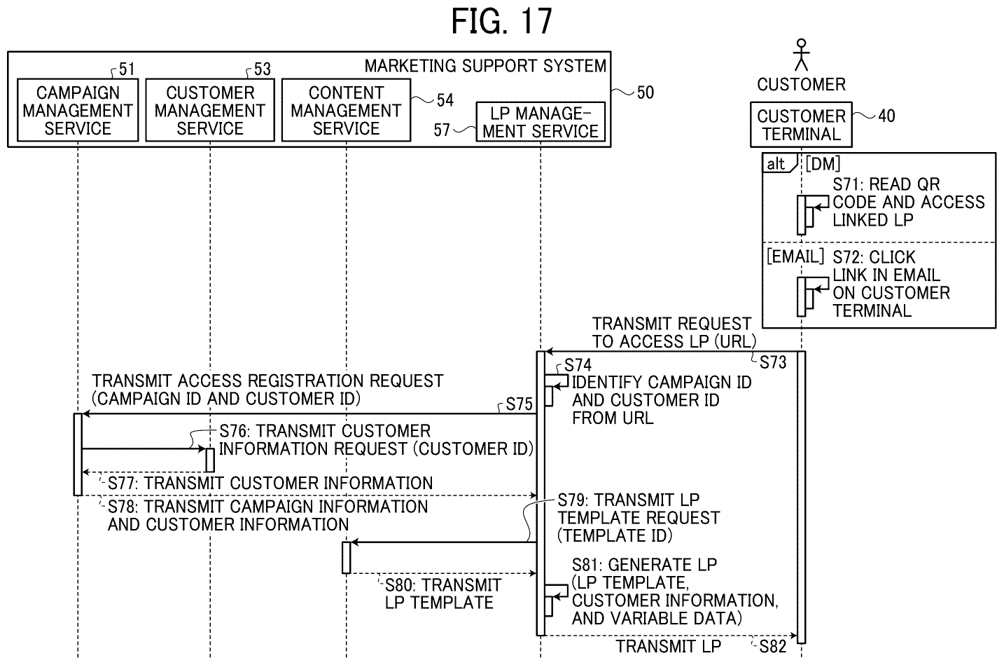

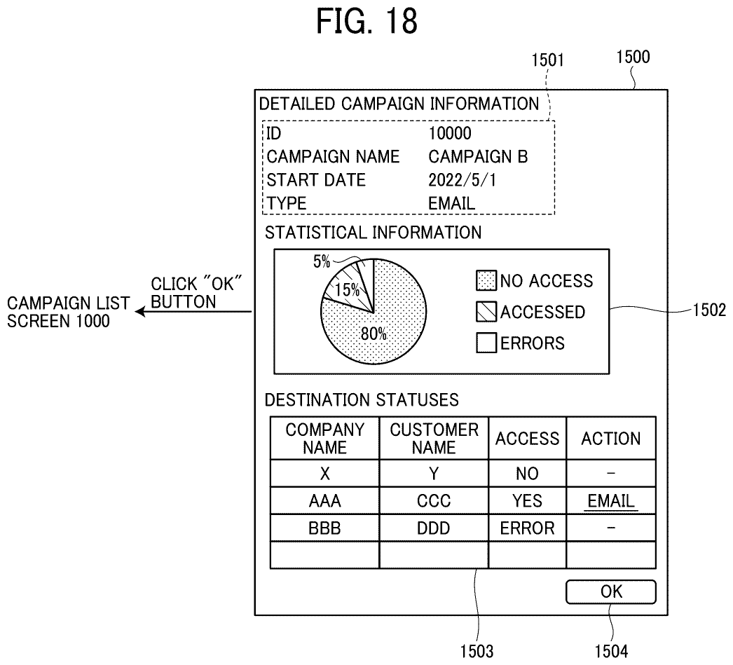

FIG. 17 is a sequence diagram illustrating an exemplary procedure of a process of accessing the LP from the customer terminal 40 in the equipment system 1 of the embodiment. FIG. 18 is a diagram illustrating an example of a detailed campaign status screen. A procedure of the LP access process in the equipment system 1 of the embodiment will be described with reference to FIGS. 17 and 18.

If the customer receives the DM from the print vendor 30, the procedure starts with step S71. If the email (the email data) is received by the customer terminal 40 of the customer, the procedure starts with step S72.

At step S71, in accordance with an operation performed by the customer having received the DM, the customer terminal 40 reads the QR code printed on the DM with the image capturing device 705, and accesses the LP indicated by the URL decoded from the read QR code.

At step S72, when the link to the URL included in the email is pressed (e.g., tapped) in accordance with an operation performed by the customer having received the email (the email data), the customer terminal 40 accesses the LP indicated by the URL.

At step S73, the communication unit 401 of the customer terminal 40 transmits a request to access the LP indicated by the URL to the LP management service 57 of the marketing support system 50.

At step S74, when the communication unit 571 of the LP management service 57 receives the request to access the LP from the customer terminal 40, the LP management unit 572 of the LP management service 57 identifies the campaign ID and customer ID from the URL indicated by the request to access the LP.

At step S75, the LP management unit 572 transmits an access registration request to the campaign management service 51 to request the registration of the request to access the LP from the customer terminal 40. The access registration request includes the campaign ID and the customer ID identified by the LP management unit 572.

At step S76, in response to receipt of the access registration request from the LP management service 57, the campaign execution management unit 517 of the campaign management service 51 transmits a customer information request to the customer management service 53. The customer information request includes the customer ID included in the access registration request. Further, in response to receipt of the access registration request from the LP management service 57, the campaign execution management unit 517 creates access information associated with the campaign ID and the customer ID included in the access registration request, includes the access date in the access information, and registers the access information in the storage unit 519. If the access registration request is not received from the LP management service 57 after the lapse of a particular period of time since the start of the campaign identified by the campaign ID, the campaign execution management unit 517 creates access information associated with the campaign ID and the customer ID of the customer, from whom the access registration request is awaited. The campaign execution management unit 517 then registers, in the storage unit 519, the access information with error information indicating that there is no access from the customer for an extended period of time.

At step S77, in response to receipt of the customer information request from the campaign management service 51, the customer management service 53 extracts, from the customer information table stored in the customer information storage unit 539, the customer information corresponding to the customer ID included in the customer information request. The customer management service 53 then transmits the extracted customer information to the campaign management service 51.

At step S78, in response to receipt of the customer information from the customer management service 53, the campaign execution management unit 517 reads, from the storage unit 519, the campaign information corresponding to the campaign ID included in the access registration request, and transmits the campaign information and the customer information to the LP management service 57.

At step S79, in response to receipt of the campaign information and the customer information from the campaign management service 51, the LP management unit 572 of the LP management service 57 transmits an LP template request to the content management service 54. The LP template request includes the template ID included in the campaign information.

At step S80, in response to receipt of the LP template request from the LP management service 57, the content management service 54 extracts, from the content stored in the content storage unit 549, the LP template corresponding to the template ID included in the LP template request. The content management service 54 then transmits the extracted LP template to the LP management service 57.

At step S81, the LP management unit 572 generates an LP with the LP template, the customer information, and the variable data included in the campaign information.

At step S82, the LP management unit 572 transmits the generated LP to the customer terminal 40 via the communication unit 571, thereby enabling the customer terminal 40 to display the LP, the access to which has been requested by the customer terminal 40.

If the marketing representative presses the CHECK DETAILS button 1203a on the campaign information screen 1200 in FIG. 15, which is displayed on the marketing representative terminal 10, the detailed campaign status screen 1500 illustrated in FIG. 18 is displayed.

The detailed campaign status screen 1500 illustrated in FIG. 18 is a screen displaying a detailed status of the started campaign. The detailed campaign status screen 1500 includes a campaign information display area 1501, a statistical information display area 1502, an individual destination status display area 1503, and an OK button 1504.

The campaign information display area 1501 is an area displaying the content of the target campaign. The campaign information display area 1501 displays the campaign ID, the campaign name, the start date, and the type, for example.

The statistical information display area 1502 is an area displaying statistical information related to the status of access to the LP from the QR code on the DM or the link in the email when the DM or email of the target campaign is delivered to a plurality of customers. For example, the statistical information is generated with the access information summarized by the campaign execution management unit 517 (an example of a generation unit) of the campaign management service 51, and is transmitted to the marketing representative terminal 10. In the example illustrated in FIG. 18, the statistical information display area 1502 displays, as the statistical information, a pie chart of the percentage of access to the LP, the percentage of no access to the LP, and the percentage of error occurrence. Herein, the term “error” refers to unsuccessful delivery of the DM to the customer or unsuccessful reception of the email by the customer terminal 40 for some reason.

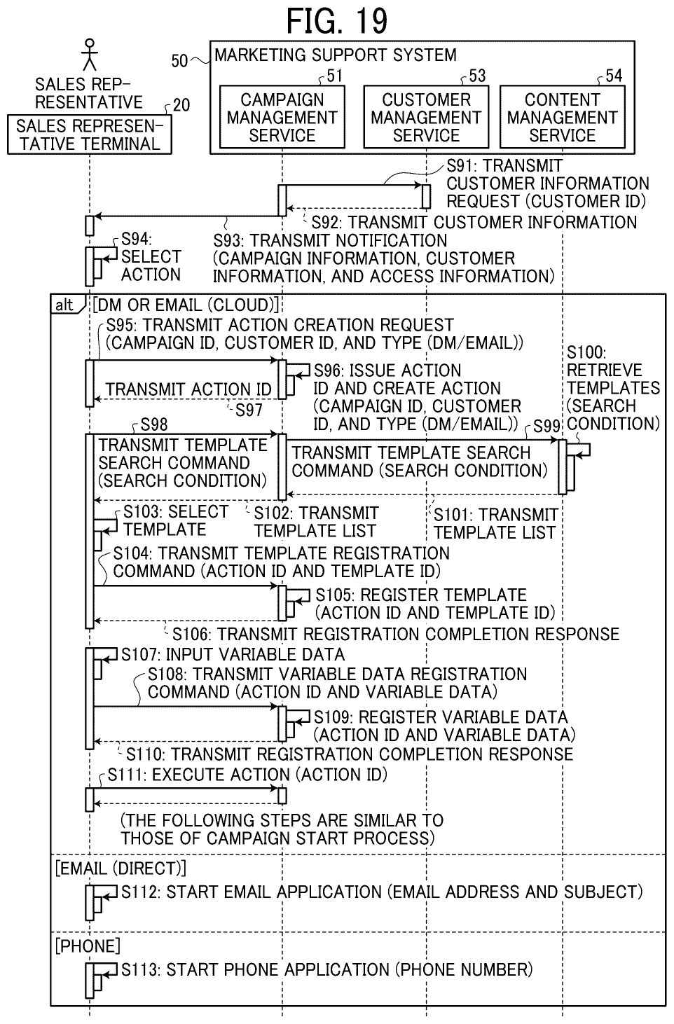

The individual destination status display area 1503 is an area displaying the status of each customer to whom the DM or email has been delivered. In the example illustrated in FIG. 18, the individual destination status display area 1503 displays the company name of the customer, the name of the customer, the status of access, and the status of action taken by the sales representative. The action taken by the sales representative will be described later with FIGS. 19 to 21.

The OK button 1504 is a button for transitioning to the campaign information screen 1200.

It is assumed here that the access to the LP from the customer terminal 40 is made to the LP management service 57 of the marketing support system 50, and that the LP is generated and displayed on the customer terminal 40. The access to and display of the LP, however, is not limited to this example. The access may be made to an external Web site, and an LP provided by the external Web site may be displayed. In this case, there may be a mechanism that transmits a notification to the marketing support system 50 in JavaScript® embedded in the LP, for example, to enable the marketing support system 50 to recognize that the LP of the external Web site has been accessed.

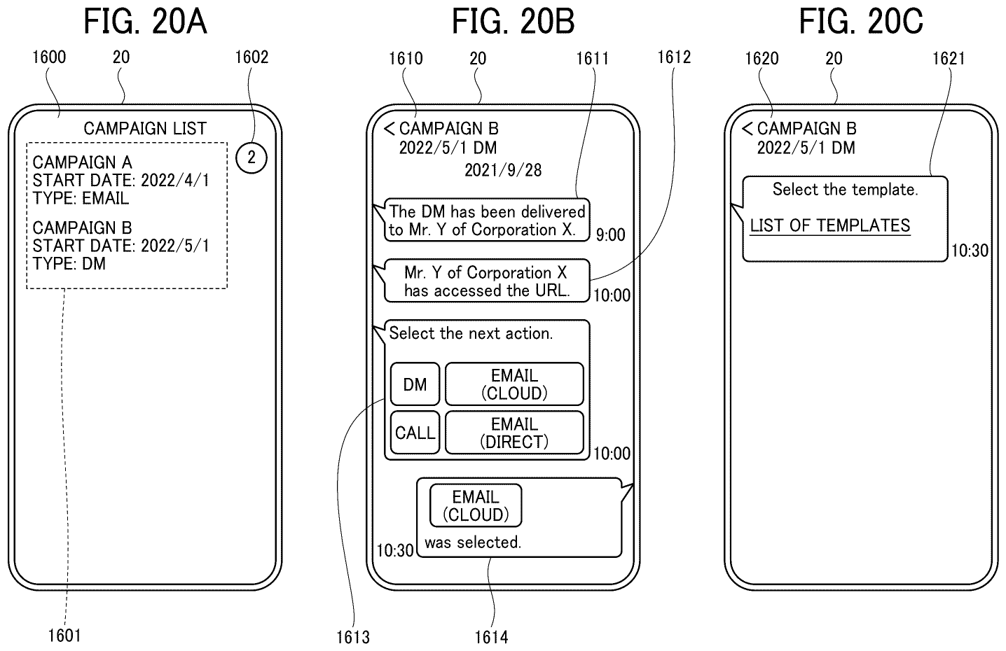

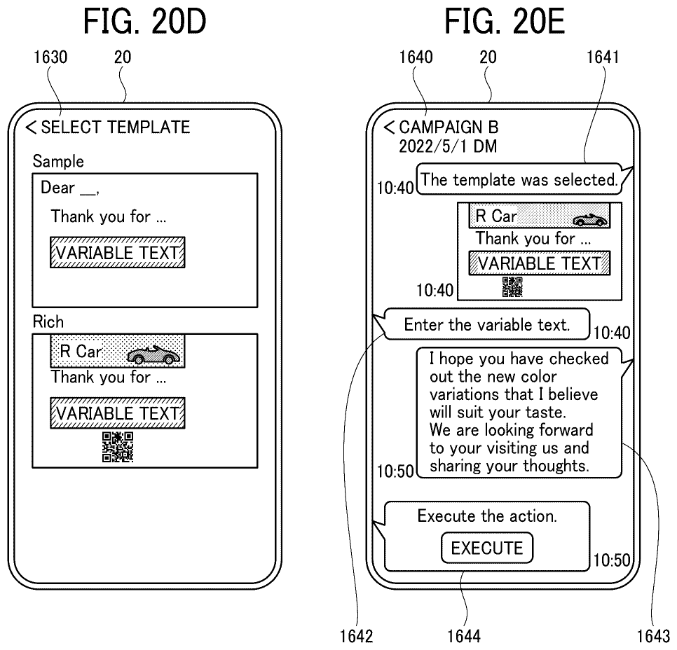

FIG. 19 is a sequence diagram illustrating an exemplary procedure of an action execution process in the equipment system 1 of the embodiment. FIGS. 20A, 20B, 20C, 20D, and 20E are diagrams illustrating examples of an application screen displayed on the sales representative terminal 20. FIG. 21 is a diagram illustrating an example of an email (an example of the second marketing data) to be delivered to the customer terminal 40.

A procedure of the action execution process in the equipment system 1 of the embodiment will be described with reference to FIGS. 19 to 21. An application related to the application screen illustrated in FIGS. 20A to 20E may be referred to as the marketing application. The marketing application is implemented by a chatbot of a messaging application or an SNS application, for example.

At step S91, upon receipt of the access registration request from the LP management service 57 at step S75 in FIG. 17 described above, the campaign execution management unit 517 of the campaign management service 51 transmits a customer information request to the customer management service 53. The customer information request includes the customer ID included in the access registration request.

At step S92, in response to receipt of the customer information request from the campaign management service 51, the customer management service 53 extracts, from the customer information table stored in the customer information storage unit 539, the customer information corresponding to the customer ID included in the customer information request. The customer management service 53 then transmits the extracted customer information to the campaign management service 51. The above-described processes of steps S91 and S92 may be the same as, or be executed separately from, the processes of steps S76 and S77 in FIG. 17 described above.

At step S93, in response to receipt of the customer information from the customer management service 53, the campaign execution management unit 517 transmits a notification to the sales representative terminal 20 via the communication unit 511. The notification includes the customer information, the campaign information corresponding to the customer information, and the access information including the access date. In this case, the campaign execution management unit 517 transmits the notification to the sales representative terminal 20 of the sales representative associated with the customer information and logged in to the marketing support system 50 via the marketing application, for example.

At step S94, with an application screen 1600 displayed on the display 715 of the sales representative terminal 20 of the sales representative, as illustrated in FIG. 20A, the sales representative checks a list of campaigns of which the sales representative is in charge.

The application screen 1600 illustrated in FIG. 20A is a screen displaying the list of campaigns of which the sales representative is in charge. The application screen 1600 includes an in-charge campaign list display area 1601 and an update count display area 1602. The in-charge campaign list display area 1601 is an area displaying the list of campaigns of which the sales representative is in charge. In the example illustrated in FIG. 20A, the in-charge campaign list display area 1601 displays the campaign name, the start date, and the type for each of the campaigns. If the sales representative taps any of campaign information areas displayed in the in-charge campaign list display area 1601, the application screen 1600 transitions to an application screen 1610 in FIG. 20B for selecting an action for the campaign, for example.

The update count display area 1602 is a display area displaying the number of changes (the number of updates) occurred in each of the campaigns (e.g., updates of the status).

It is assumed here that the sales representative has tapped the campaign information area of the in-charge campaign list display area 1601 corresponding to the above-described notification of step S93. In accordance with this tapping operation, the display control unit 202 of the sales representative terminal 20 displays the application screen 1610 of the campaign illustrated in FIG. 20B, which corresponds to the notification of step S93.

The application screen 1610 illustrated in FIG. 20B is a screen for notifying that the LP has been accessed by the customer in the selected campaign, and for prompting the sales representative to select the next action to take. The application screen 1610 includes messages 1611, 1612, 1613, and 1614, for example.

The message 1611 is a message for notifying the sales representative that the DM has been delivered to the customer. That is, the sales representative terminal 20 may be notified not only that the LP has been accessed by the customer but also that the DM has been delivered to the customer or the email has been received by the customer, as illustrated in FIG. 20B. In this case, the notification of completed delivery of the DM may be received via the marketing support system 50 from a system of a delivery company used by the print vendor 30, for example. As well as the notification of completed delivery of the DM, details of the delivery status of the DM may also be received on the sales representative terminal 20 from the system of the delivery company.

The message 1612 is a message for notifying the sales representative that the customer has accessed the LP.

The message 1613 is a message for displaying buttons for prompting the sales representative, who has checked that the customer has accessed the LP, to select the next action to take. The message 1613 is displayed with the message 1612 when the notification of step S93 is received by the sales representative terminal 20. In the example illustrated in FIG. 20B, “DM,” “EMAIL (CLOUD),” “EMAIL (DIRECT),” AND “CALL” buttons are displayed as buttons for selecting the action. Herein, the action may be understood as the type of medium or communication method for contacting the customer or the option of the type of medium or communication method. The “DM” button is a button for selecting, as the action, delivering the DM via the print management service 55 of the campaign management service 51. The “EMAIL (CLOUD)” button is a button for selecting, as the action, delivering the email via the email delivery management service 56 of the campaign management service 51. The “EMAIL (DIRECT)” button is a button for selecting, as the action, directly transmitting the email from the sales representative terminal 20 to the customer terminal 40 of the customer. The “CALL” button is a button for selecting, as the action, calling the customer terminal 40 of the customer from the sales representative terminal 20.

The message 1614 is a message indicating that “EMAIL (CLOUD)” has been selected as the action.

If “DM” or “EMAIL (CLOUD)” is selected by the sales representative in the selection of the action in the message 1613, the procedure proceeds to step S95. If “EMAIL (DIRECT)” is selected by the sales representative in the selection of the action in the message 1613, the procedure proceeds to step S112. If “CALL” is selected by the sales representative in the selection of the action in the message 1613, the procedure proceeds to step S113.

At step S95, if “DM” or “EMAIL (CLOUD)” (an example of a second medium) is selected by the sales representative in the selection of the action in the message 1613, the communication unit 201 of the sales representative terminal 20 transmits an action creation request to the campaign management service 51 of the marketing support system 50. The action creation request includes the campaign ID included in the campaign information of the notification at step S93, the customer ID, and the type of the selected action (“DM” or “EMAIL (CLOUD)”).

At step S96, when the communication unit 511 of the campaign management service 51 receives the action creation request from the sales representative terminal 20, the action creation unit 518a issues an action ID and creates action information including the action ID, the campaign ID included in the action creation request, the customer ID, and the type. The action creation unit 518a then stores the created action information in the storage unit 519.

At step S97, the action creation unit 518a transmits the issued action ID to the sales representative terminal 20 via the communication unit 511 as a response to the action creation request from the sales representative terminal 20.

At step S98, in response to the selection of “DM” or “EMAIL (CLOUD)” as the action, the sales representative terminal 20 displays an application screen 1620 illustrated in FIG. 20C.

The application screen 1620 illustrated in FIG. 20C is a screen for selecting the template to be included in the DM or email as the action. Herein, the template is data including an image (pattern) and particular text of the DM or email and the layout of the image and text. The application screen 1620 includes a message 1621, which is a message for inputting a search condition for the template. Although the message 1621 in the example of FIG. 20C simply displays a link for requesting a list of templates, the message 1621 may be designed to allow the input of a keyword for searching for templates. Alternatively, the message 1621 may display template options.

The sales representative inputs the search condition such as a keyword on the application screen 1620. Then, the communication unit 201 transmits to the campaign management service 51 a template search command including the keyword as the search condition.

At step S99, when the communication unit 511 of the campaign management service 51 receives the template search command from the sales representative terminal 20, the template selection unit 515 transmits the template search command to the content management service 54.

At step S100, in response to receipt of the template search command from the campaign management service 51, the content management service 54 retrieves templates satisfying the search condition included in the template search command from the content stored in the content storage unit 549.

At step S101, the content management service 54 transmits a list of retrieved templates to the campaign management service 51.

At step S102, in response to receipt of the list of templates from the content management service 54, the template selection unit 515 transmits the list of templates to the sales representative terminal 20 via the communication unit 511.

At step S103, when the communication unit 201 of the sales representative terminal receives the list of templates, the display control unit 202 of the sales representative terminal 20 displays a screen displaying the list of templates, such as an application screen 1630 illustrated in FIG. 20D. The sales representative taps a desired template (a second template, an example of second content) in the list of templates displayed on the application screen 1630 to select the desired template.

At step S104, the communication unit 201 transmits to the campaign management service 51 a template registration command including the action ID and the template ID of the template selected through the tapping operation performed on the application screen 1630.

At step S105, when the communication unit 511 receives the template registration command, the template selection unit 515 registers the template ID included in the template registration command into the action information created in the storage unit 519 and including an action ID matching the action ID included in the template registration command.

At step S106, the template selection unit 515 transmits a registration completion response to the sales representative terminal 20 via the communication unit 511. The registration completion response indicates that the template has been registered in the action information. When the communication unit 201 receives the registration completion response, the display control unit 202 displays a message 1641 and the selected template on an application screen 1640, as illustrated in FIG. 20E. The message 1641 indicates that the template has been selected (and registered). Thereby, the sales representative is able to recognize that the template selected on the application screen 1630 has been registered in the campaign management service 51.

At step S107, the display control unit 202 displays a message 1642 on the application screen 1640 to prompt the sales representative to input the variable data to be inserted in a variable text field of the selected template. Then, the sales representative inputs the variable data (text) (an example of the second content) to be inserted in the variable text field of the selected template. The display control unit 202 then displays the input variable data in a message 1643.

At step S108, the communication unit 201 transmits to the campaign management service 51 a variable data registration command including the input variable data and the action ID.

At step S109, when the communication unit 511 receives the variable data registration command, the variable data registration unit 516 registers the variable data included in the variable data registration command into the action information created in the storage unit 519 and including an action ID matching the action ID included in the variable data registration command.

At step S110, the variable data registration unit 516 transmits a registration completion response to the sales representative terminal 20 via the communication unit 511. The registration completion response indicates that the variable data has been registered in the action information.

At step S111, the display control unit 202 displays a message 1644 on the application screen 1640. The message 1644 includes a button for executing the action based on the created action information. Then, the sales representative presses the button displayed in the message 1644 to execute the action based on the action information. A preview screen or a message for opening the preview screen may be displayed on the application screen before the message 1644 for executing the action and after the messages received on the application. The preview screen is used to check the marketing data including the action (the type of medium for communication), the template (the data for the medium), and the variable data (the message to the customer to be included in the template), which are selected, retrieved, and input, respectively, via the messages, as described above. Further, the cost of printing the DM, the cost of using the content, the total cost to be paid to the print vender 30 by the company of the user, or the cost of use per campaign or particular time period, for example, may also be displayed.

The processes subsequent to step S111 follow those of the campaign start (execution) process illustrated in FIG. 14. FIG. 21 illustrates the email 2002 (email data) as an example of the marketing data (the second marketing data) created by the marketing data generation unit 518 through the execution of the action.

The information specified in accordance with an input operation via the message 1613 (the options of the communication medium as the action), the message 1621 (the search and selection of the template), the message 1642 (the input of the variable text), or the message 1644 (the execution of the action) is an example of second content information related to the notification that the page indicated by the first URL information has been accessed. The second content information related to the notification is information specified in accordance with an input operation performed on the second information terminal to generate the second marketing data. That is, the second content information related to the notification is understood as information associated with the notification of the access to the page indicated by the first URL information and specified after the notification in accordance with the input operation performed in response to the notification (each of the above-described messages) transmitted to the second information terminal.

Further, the selected second content information is information specified when the selection of the type of the second medium (the action toward the customer), the selection of the template of the second marketing data, and the input of the message to the customer to be included in the second marketing data are received as a series of operations performed on the second information terminal (i.e., an operation of inputting the settings of the content up to the execution of the action).

The email 2002 illustrated in FIG. 21 includes a template 2201 and a link section 2202. The template 2201 is the template selected in the above-described application screen 1630. The variable data input in the message 1643 as the variable text is inserted in the template 2201. The template 2201 further includes the link section 2202 as a link to a URL (second URL information) for accessing an LP.

At step S112, if the sales representative selects “EMAIL (DIRECT)” in the selection of the action in the message 1613, the sales representative creates and transmits an email including a subject and a message to the email address of the target customer with an email application started by the marketing application on the sales representative terminal 20. Thereby, a direct approach to the customer based on the decision of the sales representative is enabled, facilitating effective campaign execution.

At step S113, if the sales representative selects “CALL” in the selection of the action in the message 1613, the sales representative takes an action of calling the contact number of the target customer with a phone application started by the marketing application on the sales representative terminal 20. Thereby, a direct approach to the customer based on the decision of the sales representative is enabled, facilitating effective campaign execution.

The above-described execution of the action is not limited to the single execution by the sales representative. Another notification of the access to the LP via the DM or email based on the action may be received on the sales representative terminal 20 to allow the sales representative to take another action.

As described above, in the marketing support system 50 of the present embodiment, the marketing data generation unit 518 creates the first marketing data (the print data or the email data), which includes the template and the variable data specified in accordance with the operations performed on the marketing terminal 10 and the URL information according to the customer. After the first medium (the DM or email) based on the first marketing data is delivered to the customer and the LP indicated by the URL information included in the first marketing data is accessed from the customer terminal 40 of the customer, the campaign execution management unit 517 transmits the notification of the access to the LP to the sales representative terminal 20. After the notification is transmitted to the sales representative terminal 20 by the campaign execution management unit 517, the communication unit 511 receives the information of the template and the variable data specified in accordance with the operations performed on the sales representative terminal 20. The marketing data generation unit 518 then creates the second marketing data (the print data or the email data), which includes the template and the variable data indicated by the information received by the communication unit 511 and forms a basis for the second medium (the DM or email) to be delivered to the customer. Thereby, marketing workflow (whether to use the DM or email) and the content to be delivered to the customer are flexibly changed in accordance with the situation.

Further, the email as a relatively convenient method of communication or the DM with a higher open rate and a higher conversion rate is readily selected and delivered in accordance with the situation. Furthermore, marketing thus utilizing digital technologies and the DM is implemented without many tools or tasks or without high-cost, complicated system construction or workflow design. Moreover, the sales representative, for example, is able to communicate with the customer by flexibly changing a once-designed workflow in accordance with the status of communication and relationship with the customer.

A description will be given of the equipment system 1 according to a modified example of the embodiment, focusing on differences from the equipment system 1 of the foregoing embodiment.

In the above-described embodiment, the marketing data (the DM or email) is created based on the operation performed on the sales representative terminal 20 by the sales representative alone. In the modified example, a description will be given of an operation in which the marketing data is created and delivered to the customer based on actual exchange of messages between the sales representative and a provider of a good or service. A general arrangement and a functional block configuration of the equipment system 1 of the modified example and hardware configurations of apparatuses included in the equipment system 1 of the modified example are similar to those described in the foregoing embodiment.

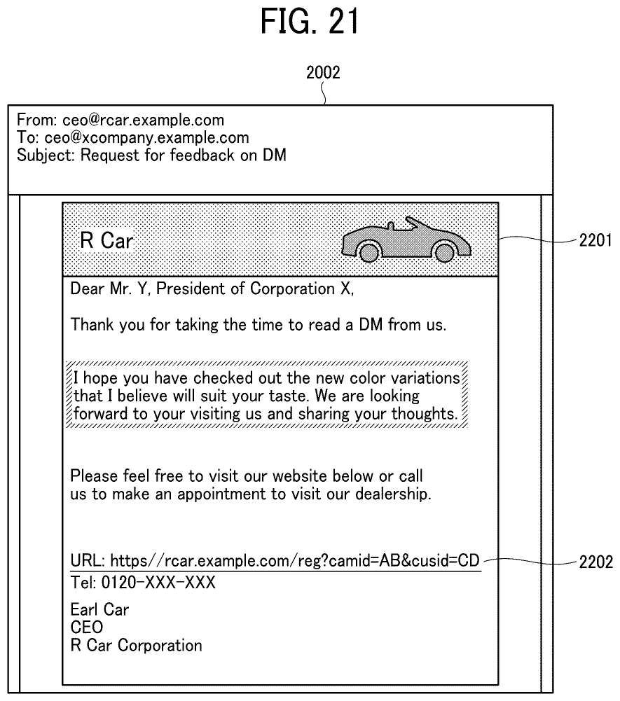

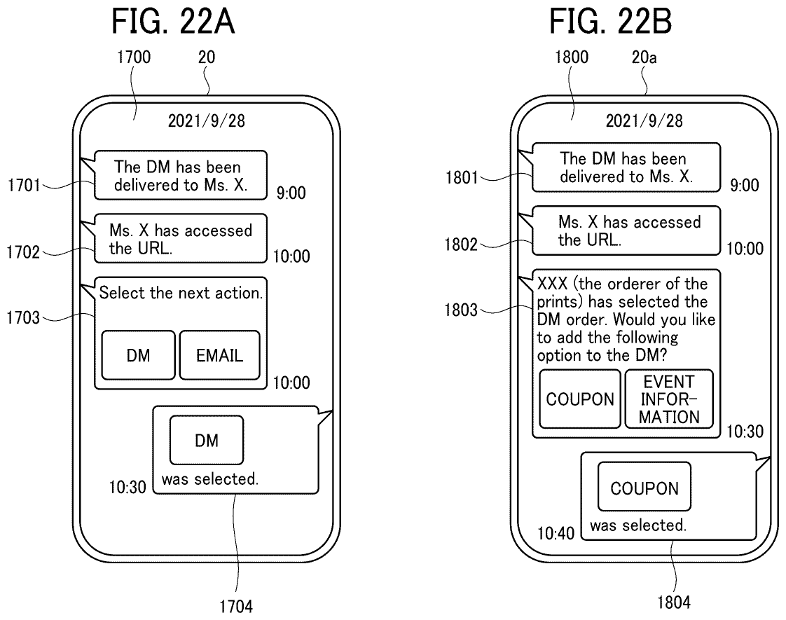

FIG. 22A is a diagram illustrating an example of the application screen displayed on the sales representative terminal 20 in the modified example. FIG. 22B is a diagram illustrating an example of the application screen displayed on a hotel terminal in the modified example. With reference to FIGS. 22A and 22B, a description will be given of an operation of creating the marketing data while exchanging data between the sales representative terminal 20 and a terminal used by the provider of the good or service.

In the following description of the modified example, it is assumed that the provider of the good or service is a hotel or accommodation business (hereinafter referred to as the hotel), and that the sales representative belongs to a travel agency. The sales representative terminal 20 illustrated in FIG. 22A is a terminal used by the sales representative of the travel agency, and a hotel terminal 20a (an example of a third information terminal) illustrated in FIG. 22B is a terminal used by the hotel. A hardware configuration and a functional block configuration of the hotel terminal 20a are similar to those of the sales representative terminal 20.

As illustrated in FIG. 22A, an application screen 1700 on the sales representative terminal 20 includes a message 1701 and a message 1702. The message 1701 is a message for notifying that the DM based on the print data as the marketing data created by the campaign management service 51 has been delivered to the customer. The message 1702 is a message for notifying that the customer has accessed the LP.

As illustrated in FIG. 22B, an application screen 1800 on the hotel terminal 20a includes a message 1801 and a message 1802. The message 1801 is a message for notifying that the DM based on the print data as the marketing data created by the campaign management service 51 has been delivered to the customer. The message 1802 is a message for notifying that the customer has accessed the LP. The information of the hotel using the hotel terminal 20a may be selected in the above-described process of creating the campaign, for example. This information may be selected as the variable data of the template; the information of different hotels may be selected for each customer. In this case, for example, the campaign management service 51 communicates with the hotel terminal 20a of the hotel associated with the customer information and logged in to the marketing support system 50 via the marketing application.

That is, the sales representative terminal 20 and the hotel terminal 20a receive, from the campaign management service 51, common messages conveying the information to be shared, such as the notification of the delivery of the DM (or the reception of the email) and the notification of the access of the customer to the LP. The application screen 1700 on the sales representative terminal 20 further displays a message 1703 for displaying buttons for prompting the sales representative, who has checked that the customer has accessed the LP, to select the next action to take, similarly to the above-described message 1613 on the application screen 1610 in FIG. 20B. It is assumed here that “DM” is selected by the sales representative in the selection of the action in the message 1703.

Then, the communication unit 201 of the sales representative terminal 20 transmits an action creation request to the campaign management service 51 of the marketing support system 50. The action creation request includes the campaign ID included in the campaign information, the customer ID, and the type of the selected action (“DM” or “EMAIL (CLOUD)”).

When the communication unit 511 of the campaign management service 51 receives the action creation request from the sales representative terminal 20, the action creation unit 518a issues an action ID and creates action information including the action ID and the campaign ID, the customer ID, and the type included in the action creation request. The action creation unit 518a then stores the created action information in the storage unit 519. The action creation unit 518a further transmits the issued action ID to the sales representative terminal 20 and the hotel terminal 20a via the communication unit 511 as a response to the action creation request from the sales representative terminal 20.

In this process, the campaign execution management unit 517 of the campaign management service 51 transmits a notification to the hotel terminal 20a via the communication unit 511 to notify that “DM” has been selected on the sales representative terminal 20. When the communication unit 201 of the hotel terminal 20a receives the notification, the display control unit 202 of the hotel terminal 20a displays, on the application screen 1800, a message 1803 indicating that “DM” was has been selected on the sales representative terminal 20. As well as indicating that “DM” has been selected on the sales representative terminal 20, the message 1803 displays buttons for allowing the hotel to select whether to include “COUPON” or “EVENT INFORMATION” in the DM, for example, as illustrated in FIG. 22B. Thereby, not only what is intended by the sales representative but also what is desired by the provider of the good or service (the hotel in this case), e.g., “COUPON” or “EVENT INFORMATION” in this case, is included in the content of the DM or email to be delivered to the customer.

If the hotel selects and presses the “COUPON” button in the message 1803, for example, the display control unit 202 of the hotel terminal 20a displays a message 1804 indicating that “COUPON” has been selected. The hotel terminal 20a then transmits content and an action ID corresponding to “COUPON” to the campaign management service 51.

The campaign management service 51 registers the content in the storage unit 519 in association with action information identified by the action ID. The content is included in the print data of the DM or the email data of the email when the print data or the email data is created.

As described above, in the marketing support system 50 of the modified example, the communication unit 511 receives the information of the content (e.g., coupon or event information) determined through the exchange of messages between the sales representative terminal 20 and the hotel terminal 20a of the provider of the good or service. Consequently, the print data of the DM or the email data of the email with timely content based on the response of the customer is created in cooperation with the direct provider of the good or service.

In the foregoing embodiment or modified example, if at least one of the functional units of the marketing support system 50, the marketing representative terminal 10, the sales representative terminal 20, the hotel terminal 20a, or the job management server 31 is implemented through the execution of a program, the program is provided as previously stored in a storage device such as a ROM. Further, in the embodiment or modified example, a program executed by the marketing support system 50, the marketing representative terminal 10, the sales representative terminal 20, the hotel terminal 20a, or the job management server 31 may be provided as recorded on a computer readable recording medium, such as a CD-ROM, a flexible disk (FD), a CD-R, or a DVD, in an installable or executable format file. Further, in the embodiment or modified example, the program may be stored in a computer connected to a network such as the Internet and be provided as downloaded via the network, or may be provided or distributed via a network such as the Internet. Further, in the embodiment or modified example, the program is configured as a module including at least one of the above-described functional units. As an actual hardware configuration, a CPU reads and executes the program from the above-described storage device, thereby loading and generating the least one of the functional units on a main storage device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The present disclosure relates to the following aspects.

According to a first aspect, an information processing system includes a first creation unit, a notification unit, a reception unit, and a second creation unit. The first creation unit creates first marketing data including first content and first URL information. The first content is specified in accordance with an operation performed on a first information terminal. The first URL information is according to a customer. After a first medium based on the first marketing data is delivered to the customer and a page indicated by the first URL information included in the first marketing data is accessed from an information terminal of the customer, the notification unit transmits a notification to a second information terminal to notify the access to the page. The reception unit receives second content information. The second content information is specified in accordance with an operation performed on the second information terminal, and is related to the notification transmitted to the second information terminal by the notification unit. The second creation unit creates second marketing data including second content and related to the customer. The second content is indicated by the second content information received by the reception unit.

According to a second aspect, in the information processing system of the first aspect, the second content information related to the notification is specified in accordance with an input operation performed on the second information terminal to generate the second marketing data as a basis for a second medium related to the customer. The second content information is associated with the notification of the access to the page indicated by the first URL information, and is specified after the notification in response to the input operation performed in response to the notification transmitted to the second information terminal.

According to a third aspect, in the information processing system of the second aspect, the second content information is information specified in response to receipt of a series of operations performed on the second information terminal. The series of operations includes selection of a type of the second medium, selection of a template of the second marketing data, and input of a message to the customer to be included in the second marketing data.

According to a fourth aspect, in the information processing system of the first aspect, the first information terminal receives selection of direct mail or electronic mail as the first medium. When the first information terminal receives the selection of the direct mail as the first medium, the first creation unit creates, as the first marketing data, print data including a two-dimensional code generated based on the first URL information. When the first information terminal receives the selection of the electronic mail as the first medium, the first creation unit creates, as the first marketing data, electronic mail data including a link to the first URL information.

According to a fifth aspect, in the information processing system of the second aspect, the second marketing data includes second URL information according to the customer.

According to a sixth aspect, in the information processing system of the fifth aspect, the second information terminal receives selection of direct mail or electronic mail as the second medium. When the second information terminal receives the selection of the direct mail as the second medium, the second creation unit creates, as the second marketing data, print data including a two-dimensional code generated based on the second URL information. When the second information terminal receives the selection of the electronic mail as the second medium, the second creation unit creates, as the second marketing data, electronic mail data including a link to the second URL information.

According to a seventh aspect, in the information processing system of one of the first to sixth aspects, the reception unit receives, as the second content, text input in accordance with an operation performed on the second information terminal.

According to an eighth aspect, in the information processing system of one of the first to seventh aspects, the first marketing data created by the first creation unit includes a first template as the first content specified in accordance with the operation performed on the first information terminal.

According to a ninth aspect, in the information processing system of one of the first to eighth aspects, the second marketing data created by the second creation unit includes a second template as the second content specified in accordance with the operation performed on the second information terminal.

According to a tenth aspect, the information processing system of one of the first to ninth aspects further includes a generation unit. In response to delivery of the first medium based on the first marketing data to a plurality of customers, the generation unit generates and transmits statistical information to the first information terminal. The statistical information summarizes a status of access to the page indicated by the first URL information.

According to an eleventh aspect, in the information processing system of one of the first to tenth aspects, the second content information received by the reception unit is determined through exchange of a plurality of messages between the second information terminal and a third information terminal used by a provider of a good or service.

According to a twelfth aspect, in the information processing system of one of the first to eleventh aspects, the second information terminal is installed with a messaging application that implements a display control unit. The display control unit displays a screen for sequentially displaying the notification from the notification unit of the access to the page and an input field for inputting the second content, and for receiving specification of the second content to be included in the second marketing data in accordance with an operation performed on the input field.

According to a thirteenth aspect, the information processing system of one of the first to eleventh aspects further includes a campaign information creation unit. In accordance with an instruction from an information terminal, the campaign information creation unit creates campaign information including content and customer information. The first creation unit creates the first marketing data with the campaign information. The second creation unit creates the second marketing data after the access from the information terminal of the customer to the page.

According to a fourteenth aspect, an information processing apparatus includes a first creation unit, a notification unit, a reception unit, and a second creation unit. The first creation unit creates first marketing data including first content and URL information. The first content is specified in accordance with an operation performed on a first information terminal. The URL information is according to a customer. After a first medium based on the first marketing data is delivered to the customer and a page indicated by the URL information included in the first marketing data is accessed from an information terminal of the customer, the notification unit transmits a notification to a second information terminal to notify the access to the page. The reception unit receives second content information. The second content information is specified in accordance with an operation performed on the second information terminal, and is related to the notification transmitted to the second information terminal by the notification unit. The second creation unit creates second marketing data including second content and related to the customer. The second content is indicated by the second content information received by the reception unit.

According to a fifteenth aspect, an information processing method includes creating first marketing data including first content and URL information. The first content is specified in accordance with an operation performed on a first information terminal. The URL information is according to a customer. The information processing method further includes, after a first medium based on the first marketing data is delivered to the customer and a page indicated by the URL information included in the first marketing data is accessed from an information terminal of the customer, transmitting a notification to a second information terminal to notify the access to the page, and receiving second content information. The second content information is specified in accordance with an operation performed on the second information terminal, and is related to the notification transmitted to the second information terminal. The information processing method further includes creating second marketing data including second content and related to the customer. The second content is indicated by the received second content information.

According to a sixteenth aspect, a non-transitory recording medium stores a plurality of instructions which, when executed by a computer, causes the computer to perform an information processing method. The information processing method includes creating first marketing data including first content and URL information. The first content is specified in accordance with an operation performed on a first information terminal. The URL information is according to a customer. The information processing method further includes, after a first medium based on the first marketing data is delivered to the customer and a page indicated by the URL information included in the first marketing data is accessed from an information terminal of the customer, transmitting a notification to a second information terminal to notify the access to the page, and receiving second content information. The second content information is specified in accordance with an operation performed on the second information terminal, and is related to the notification transmitted to the second information terminal. The information processing method further includes creating second marketing data including second content and related to the customer. The second content is indicated by the received second content information.

According to a seventeenth aspect, an information processing method performed by a terminal apparatus includes receiving input of an operation performed on the terminal apparatus, and after a first medium based on first marketing data including first content and URL information is delivered to a customer and a page indicated by the URL information included in the first marketing data is accessed from an information terminal of the customer, receiving a notification of the access to the page. The first content is specified in accordance with an operation performed on the terminal apparatus. The URL information is according to the customer. The information processing method further includes transmitting second content information, which is specified in accordance with an operation performed on the terminal apparatus and is related to the received notification.

According to an eighteenth aspect, a non-transitory recording medium stores a plurality of instructions which, when executed by a terminal apparatus, causes the terminal apparatus to perform an information processing method. The information processing method includes receiving input of an operation performed on the terminal apparatus, and after a first medium based on first marketing data including first content and URL information is delivered to a customer and a page indicated by the URL information included in the first marketing data is accessed from an information terminal of the customer, receiving a notification of the access to the page. The first content is specified in accordance with an operation performed on the terminal apparatus. The URL information is according to the customer. The information processing method further includes transmitting second content information, which is specified in accordance with an operation performed on the terminal apparatus and is related to the received notification.

A typical system runs processes in accordance with a preset rule, such as following a workflow of delivering a DM, checking the access to a Web page, and delivering another DM, consequently making it difficult to freely change the content to be delivered to the customer. In view of this, one or more embodiments described above provide a system allowing a user to change the content to be delivered to the customer.

1. An information processing system comprising:
circuitry configured to
create first marketing data including first content and first uniform resource locator (URL) information, the first content being specified in accordance with an operation performed on a first information terminal, and the first URL information being according to a customer,
in response to access by a terminal of the customer to a page indicated by the first URL information included in the first marketing data after a first medium based on the first marketing data is delivered to the customer, transmit an access notification to a second information terminal to notify the access to the page indicated by the first URL information,
receive second content information related to the access notification and specified in accordance with an operation performed on the second information terminal, and
create second marketing data related to the customer and including second content indicated by the received second content information.

2. The information processing system of claim 1, wherein the second content information is associated with the access notification and specified in accordance with an input operation performed on the second information terminal in response to the access notification, and
wherein based on the second content information, the circuitry creates the second marketing data as a basis for a second medium related to the customer.

3. The information processing system of claim 2, wherein the second content information is specified in response to receipt of a series of operations performed on the second information terminal, the series of operations including selection of a type of the second medium, selection of a template of the second marketing data, and input of a message to the customer to be included in the second marketing data.

4. The information processing system of claim 1, wherein the circuitry receives, from the first information terminal, selection of direct mail or electronic mail selected as the first medium on the first information terminal,
wherein in response to receipt of the selection of the direct mail as the first medium, the circuitry creates, as the first marketing data, print data including a two-dimensional code generated based on the first URL information, and
wherein in response to receipt of the selection of the electronic mail as the first medium, the circuitry creates, as the first marketing data, electronic mail data including a link to the first URL information.

5. The information processing system of claim 2, wherein the second marketing data includes second URL information according to the customer.

6. The information processing system of claim 5, wherein the circuitry receives, from the second information terminal, selection of direct mail or electronic mail selected as the second medium on the second information terminal,
wherein in response to receipt of the selection of the direct mail as the second medium, the circuitry creates, as the second marketing data, print data including a two-dimensional code generated based on the second URL information, and
wherein in response to receipt of the selection of the electronic mail as the second medium, the circuitry creates, as the second marketing data, electronic mail data including a link to the second URL information.

7. The information processing system of claim 1, wherein the circuitry receives, as the second content, text input in accordance with an operation performed on the second information terminal.

8. The information processing system of claim 1, wherein the first marketing data created by the circuitry includes a first template as the first content specified in accordance with the operation performed on the first information terminal.

9. The information processing system of claim 1, wherein the second marketing data created by the circuitry includes a second template as the second content specified in accordance with the operation performed on the second information terminal.

10. The information processing system of claim 1, wherein in response to delivery of the first medium based on the first marketing data to a plurality of customers, the circuitry generates and transmits statistical information to the first information terminal, the statistical information summarizing a status of access to the page indicated by the first URL information.

11. The information processing system of claim 1, wherein the second content information received by the circuitry is determined through exchange of a plurality of messages between the second information terminal and a third information terminal used by a provider of a good or service.

12. The information processing system of claim 1, further comprising the second information terminal, the second information terminal including terminal circuitry configured to execute a messaging application to
sequentially display, on a screen, the access notification and an input field for inputting the second content, and
receive, via the screen, specification of the second content to be included in the second marketing data in accordance with an operation performed on the input field.

13. The information processing system of claim 1, wherein the circuitry
creates campaign information in accordance with an instruction from an information terminal, the campaign information including content and customer information,
creates the first marketing data with the campaign information, and
creates the second marketing data after the access by the terminal of the customer to the page.

14. An information processing apparatus comprising:
circuitry configured to
create first marketing data including first content and first URL information, the first content being specified in accordance with an operation performed on a first information terminal, and the first URL information being according to a customer,
in response to access by a terminal of the customer to a page indicated by the first URL information included in the first marketing data after a first medium based on the first marketing data is delivered to the customer, transmit an access notification to a second information terminal to notify the access to the page indicated by the first URL information,
receive second content information related to the access notification and specified in accordance with an operation performed on the second information terminal, and
create second marketing data related to the customer and including second content indicated by the received second content information.

15. An information processing method comprising:
creating first marketing data including first content and first URL information, the first content being specified in accordance with an operation performed on a first information terminal, and the first URL information being according to a customer;
in response to access by a terminal of the customer to a page indicated by the first URL information included in the first marketing data after a first medium based on the first marketing data is delivered to the customer, transmitting an access notification to a second information terminal to notify the access to the page indicated by the first URL information;
receiving second content information related to the access notification and specified in accordance with an operation performed on the second information terminal; and
creating second marketing data related to the customer and including second content indicated by the received second content information.

16. A non-transitory recording medium storing a plurality of instructions which, when executed by one or more processors, causes the processors to perform the information processing method of claim 15.
